(19) United States
(12) Patent Application Publication
(10) Pub. No.: US 2009/0144186 A1
(43) Pub. Date: Jun. 4, 2009

(54) Financial Product Design and Implementation

(75) Inventor: Christophe Debarre, Jouy En Josas (FR)

Correspondence Address: BANNER & WITCOFF, LTD., 1100 13th STREET, N.W., SUITE 1200, WASHINGTON, DC, 20005-4051, US

(73) Assignee: Reuters SA, Geneva (CH)

(21) Appl. No.: 12/270,117

(22) Filed: Nov. 13, 2008

Related U.S. Application Data
(60) Provisional application No. 60/991,360, filed on Nov. 30, 2007.

(51) Int. Cl. G06Q 40/00

(52) U.S. Cl. 705/37; 705/35

(57) ABSTRACT

A front-to-back application suite may integrate new financial products on the fly, without a long development phase. A financial product type, such as a derivative product or structured product, may be created and integrated into a financial management suite for pricing, risk management analysis, deal capture, and trading activities. Information describing a financial product type, including one or more financial instruments and parameters, is received via a user interface and a meta language data script is generated to define the financial product type. A corresponding software object may be generated from the markup language data script and then invoked, for example, by interpreting code of the software object via a virtual machine. The new financial product type may be integrated into the financial management suite, so that specific deals may be created based on the financial product type and then trading activities involving the new deal may be performed within the financial management suite.

The present application claims priority to U.S. provisional application Ser. No. 60/991,360, filed on Nov. 30, 2007, the entire disclosure of which is hereby incorporated by reference.

### BACKGROUND

Trading activities in today's financial markets often involve financial products that are much more complex than basic stocks, bonds, and other simple commodities. Derivative products, for example, are complex financial products whose value may change in response to changes in any of several different market variables, such as interest rates, equity or commodity prices, or foreign exchange rates. As another example, structured products are single investments whose return may depend on many different financial instruments, such as bonds, currency options, and other derivatives products. Derivatives and structured products, along with other complex financial products often require a sophisticated risk analysis and pricing processes so that the product is fully evaluated before it is presented to customers and traded in financial markets.

When designing, pricing, building, and invoking financial products for investors, speed and precision are both of vital importance. On one hand, if a new structured product is not made available quickly to investors, the product might not be viewed as innovative in the marketplace. Market trends can change quickly, and a firm that fails to provide a new financial product to its customers in a timely manner may face a competitive disadvantage. On the other hand, developing financial products is a complex process, and any errors in pricing or risk analysis may expose investors and the firm providing the product to unanticipated risks and the potential for serious financial loss. Before a proposed structured product can be made available to customers, a firm must properly hedge the proposed product, monitor the embedded risks and validate the pricing model over the life cycle of the deal definition.

Typically, after a firm designs a new complex financial product, the firm must wait for its information technology and quantitative analysis personnel to build and validate the new product before putting it in production. Specifically, computer programmers must code the new product structures into the firm's pricing and trade processing system, and then create and validate in-house proprietary pricing models for the new product. Not only is valuable time lost in these processes, but also the increased number of steps required to create the new structured product increases the opportunities for coding, testing, and pricing errors. Furthermore, new complex financial products often cannot be risk managed in the same system as other asset classes, but may use different methodologies and risk management interfaces. In these scenarios, the multiple risk systems might need to be manually linked, for example, using a conventional spreadsheet application to transfer the risk analysis data. These multiple systems increase the interface maintenance costs for the firm, and create the additional operational risk issues of losing or corrupting risk data.

Additionally, investment firms may have regulatory and internal compliance standards to meet, for example, for trading procedures, reporting, and computation of fair value prices. These standards may increase the delay for each different system and processing step, causing further delay in presenting a new complex financial product to traders and potentially reducing firm profitability.

Accordingly, there remains a need for techniques of designing and implementing complex financial products, such as structured products and derivative products, and integrating these products into financial product management applications.

### SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a financial product, such as a structured product or derivative, may be created by providing a computer user interface operating in connection with a financial management software application. User input may be received describing a new type of financial product, or extending an existing product type, in which the input includes one or more financial instrument and a set of characteristics or parameters for the financial product. A meta language may be used to describe many different kinds of products and product types. Additionally, the meta language may allow the definition of building blocks that are able to be reused to create and validate multiple different products. When the user input is received, a proprietary meta language script may be generated defining the new or modified financial product. The meta language may be defined by, for example, an XML object or file. The markup language data script may be stored in a library of financial product definitions, and a corresponding software object representing the financial product may be created and invoked within the financial management application. For example, the code of the software object may be interpreted by a virtual machine running on the same computer system as the financial management software application, thus potentially allowing rapid creation and more seamless integration of new or modified financial products into a financial management application.

According to an additional aspect of the present disclosure, the newly created or modified financial product may be invoked via the financial management application in a trading activity, such as buying or selling, or risk management analysis. By integrating the new financial product, the trading activities may also be performed together with the trading activities of other financial products available for trading in the same financial management system. According to yet another aspect of the present disclosure, the user interface may be configured to allow users to price a new financial product, for example, by selecting a pricing model from an external library and setting parameters for the pricing model from within the user interface. According to additional aspects of the present disclosure, the user interface for pricing and performing trading activities with new or modified financial products may be updated dynamically to invoke and position controls and data fields on the user interface in real time, based on user selections of the financial product, pricing model, and other variables. The user interface may also support testing of one or more pricing scenarios on the new product by providing simulations using actual market data received via the financial management application. Additionally, the user interface and the financial management application may support the manual input of market data by users, as well as solving capabilities such as matching a set of criteria against a given price.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a computing device, in accordance with aspects of the present invention;

FIG. 2 is a flow diagram showing illustrative steps for implementing a new financial product and integrating the product into a financial management system, in accordance with aspects of the present invention;

FIG. 3 is a block diagram illustrating interactive software components within a financial management system, in accordance with aspects of the present invention;

FIG. 4 is an illustrative block diagram representing a deal component based on a financial product or block, a set of attributes, and a set of properties, in accordance with aspects of the present invention;

FIG. 5 is a block diagram illustrating a software component architecture of a financial management system, in accordance with aspects of the present invention;

FIG. 6 is a screenshot from an illustrative user interface for receiving user input and generating a new financial product within a financial management system, in accordance with aspects of the present invention;

FIGS. 7A and 7B show a sample block of markup language code relating to a financial product, in accordance with aspects of the present invention;

FIG. 8 is an illustrative user interface for viewing and editing a payoff script for a financial product within a financial management system, in accordance with aspects of the present invention;

FIG. 9 is an illustrative object schema for storing financial products in a financial management system, in accordance with aspects of the present invention;

FIGS. 10-13 are screenshots from illustrative user interfaces for trading, pricing, and analyzing financial products within a financial management system, in accordance with aspects of the present invention;

FIG. 14 is an illustrative state diagram representing multiple different stages in the life cycle of a financial product type, in accordance with aspects of the present invention;

FIG. 15 is an illustrative flow diagram including certain user roles and associated responsibilities within the financial management system, in accordance with aspects of the present invention;

FIG. 16 is a screenshot from an illustrative user interface for editing external pricing functions associated with a selected pricing model, in accordance with aspects of the present invention;

FIG. 17 is a screenshot from an illustrative user interface displaying a trace of a payoff script, in accordance with aspects of the present invention; and

FIG. 18 is a screenshot from an illustrative user interface displaying a trace of a rules engine, in accordance with aspects of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

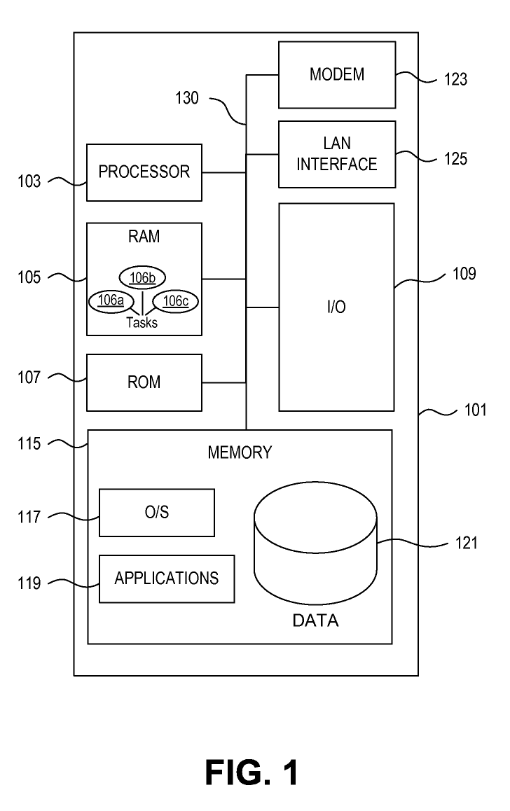

FIG. 1 illustrates a block diagram of a generic computing device 101 that may be used in accordance with certain embodiments of the invention. Device 101 may include a processor 103 for controlling the overall operation of the computing device and its associated components, including RAM 105, ROM 107, input/output module 109, and memory 115. Also shown inside the RAM 105 are applications 106a-106c, representing the application data stored in RAM memory 105 while the computer is on and corresponding software applications (e.g., software tasks) are running on the computer 101, including, for example, system applications and user applications, such as native applications or managed applications executed in a managed runtime environment. Thus, computer 101 typically includes a variety of computer readable media, and combinations of any of the above should also be included within the scope of computer readable media.

I/O 109 may include a microphone, keypad, touch screen, and/or stylus through which a user of device 101 may provide input, and may also include one or more of a speaker for providing audio output and a video display device for providing textual, audiovisual and/or graphical output. I/O 109 may also include a user interface including such physical components as a voice interface, one or more arrow keys, joystick, data glove, mouse, roller ball, or the like. Memory 115 may store software used by device 101, such as an operating system 117, application programs 119, and associated data 121. Additionally, an application program 119 used by device 101 according to an illustrative embodiment of the invention may include computer executable instructions for invoking system and/or user functionality. For example, an application program 119 used by the device 101 according to an illustrative embodiment of the invention may include computer executable instructions for invoking user functionality related to communication, such as email, short message service (SMS), multimedia messaging service (MMS), and voice input and speech recognition applications.

The device 101 may operate as a server in a networked environment supporting connections to one or more remote computers, such as personal computers, mobile devices, or other servers that include many or all of the elements described above relative to device 101. Thus, the device 101 may support connections to various networks, including local area networks (LANs), wide area networks (WANs), and many other varieties of communication networks. When used in an Ethernet or other LAN networking environment, the server 101 may be connected to the LAN through a network interface or adapter 125. When used in a WAN networking environment, the server 101 may employ a modem 123 or other techniques for establishing communications over the WAN. It will be appreciated that the network connections described herein are illustrative and other techniques for establishing communications links between computers may be used.

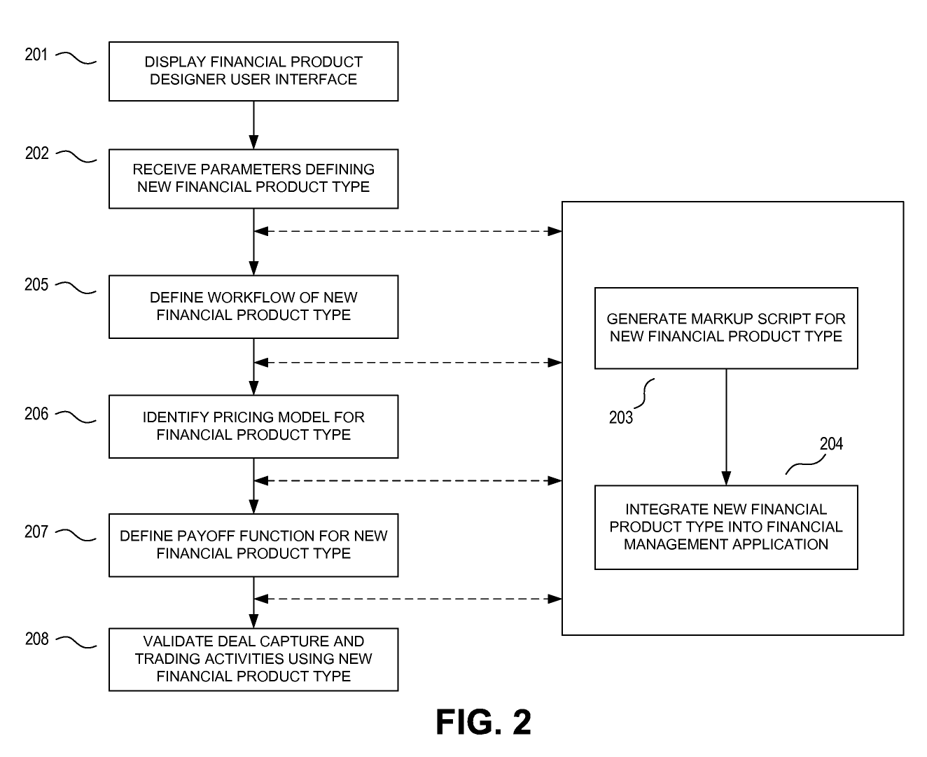

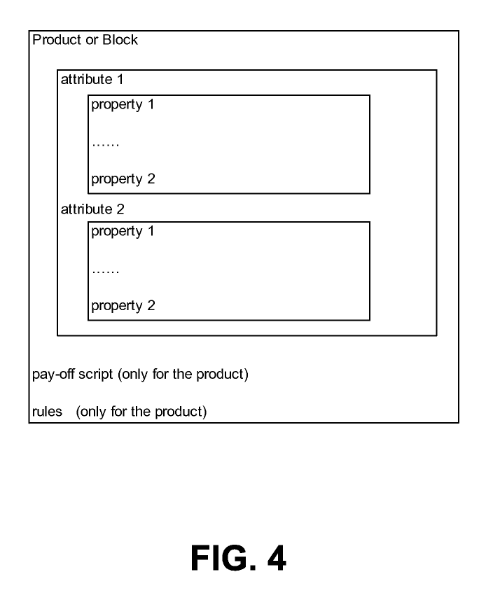

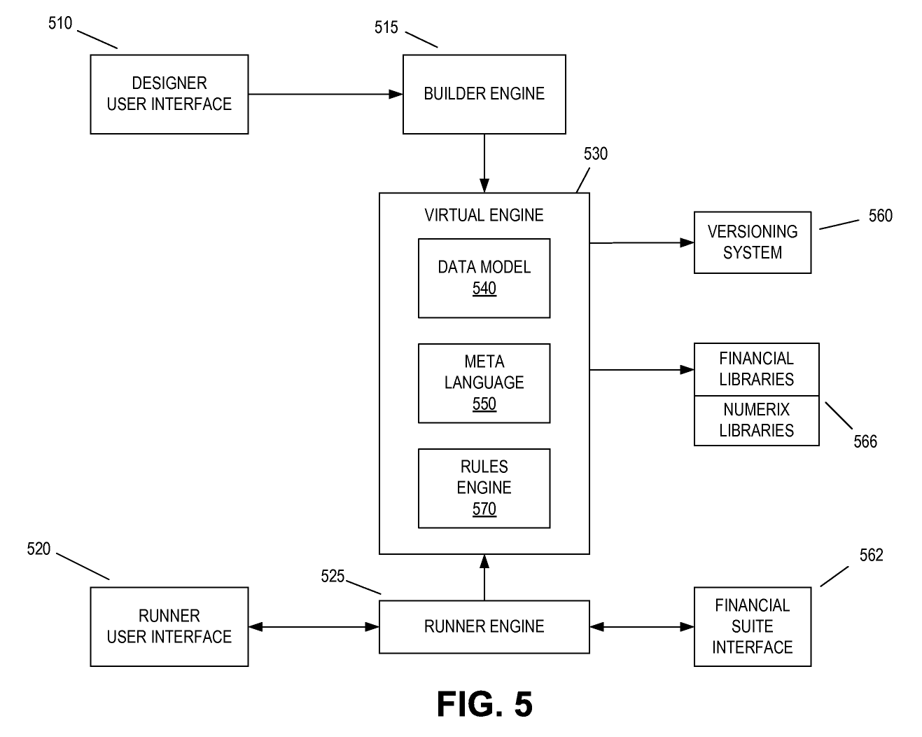

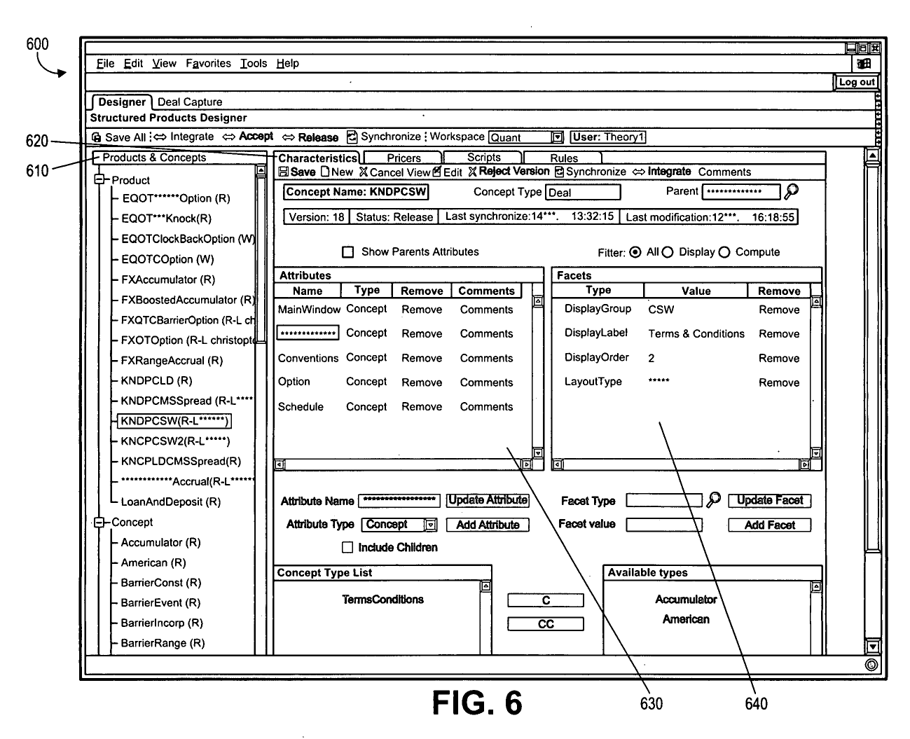

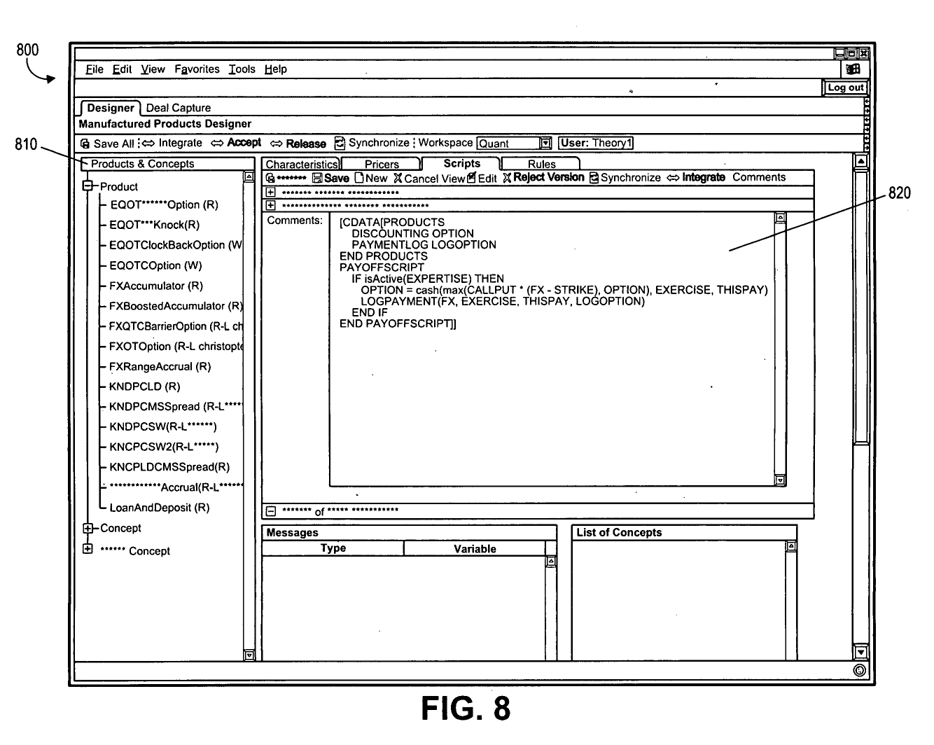

Referring to FIG. 2, a flow diagram is shown illustrating steps for creating and using a new type of financial product in accordance with aspects of the present invention, including defining, pricing, validating, and deal generation for new types of financial products. In steps 201-208, a new financial product is designed and implemented using a financial management software application. The financial management software application used to implement the new type of product may be operated under control of a user, for example, a financial analyst that uses the functionality and interfaces provided by the software application to define the characteristics of the new type of financial product. For the purposes of the present disclosure, a type of financial product may include any quantifiable financial instrument (e.g., commodity, stock, interest rate, or other asset) from any asset class, instrument type, and financial market. Other examples of financial products may include basket indexes, such as atlas options, quanto atlas range accrual swaps, snowball range accrual swaps, and lookback options. Financial product types also include derivatives products, structured products, and other complex financial product types. As mentioned above, derivatives and other structured products may be made up of combinations of multiple different financial instruments, and may include user-defined properties and other characteristics for the new product. For example, a structured financial product including a swap deal may be used to define a range accrual swap. As another example, if a user creates a target redemption leg block (e.g., the block shown in FIG. 4) then the user may combine this block with a standard funding leg block to obtain a target redemption swap, and then may add a set of user-defined properties to this block to obtain a target redemption note financial product (see Appendix E). Thus, a robust user interface may be provided to allow a financial product designer or financial analyst to define the financial instruments, parameters, and other market variables corresponding to the new structured product by creating and combining building block products. The illustrative techniques and user interfaces for creating new structured products are included below in the description of FIGS. 5-10 (see, e.g., FIG. 6, FIG. 8).

In step 201, the financial management system provides a product designer user interface for the user (e.g., a product designer or financial analyst). Various user interface controls and input data fields may be provided on the user interface to allow the user to identify one or more types of financial instruments from a list of product types and instrument types from different markets. For example, the designer user interface may include a dropdown component allowing the user to select an instrument type (e.g., asset, bond, equity, index, etc.), and after an instrument type is selected, a list component positioned proximately to the dropdown box may be automatically populated with financial instruments of the selected type. A structured product or derivative created using the products designer may include multiple different financial instruments, as well as different parameters that may depend on the instruments selected. Thus, the user interface may include additional input fields to allow users to select multiple instruments and the properties/parameters corresponding to the instruments selected. The products designer user interface may also include user-definable fields (e.g., text boxes), allowing the product designer or analyst to define and set their own custom properties for a financial product type. In certain examples, blocks of related input data fields may be implemented with a common set of programming logic (see meta language model 550 of FIG. 5), and may be positioned together in the designer user interface. These blocks (540 and 560 of FIG. 5) may be stored together and reused as needed when different financial products are created or modified, thereby potentially reducing unnecessary code duplication. In some examples, object inheritance may also be used when designing new types of financial products (see meta language model 550 of FIG. 5), so that product type definitions can be based on related existing types of financial products. For example, the designer user interface may provide the user with controls and interface components to identify and set an inheritance relationship between different product types. For instance, a new structured product type might be initially defined as a sub-class (or child) of an existing structured product type, and then modified to include any additional instruments and/or parameters that are applicable to the new product type but not to the parent. Accordingly, the designer user interface in step 201 might include a search function allowing users to locate an existing product type on the system and designate it as a template product type or parent product type to serve as the basis for the new type of financial product.

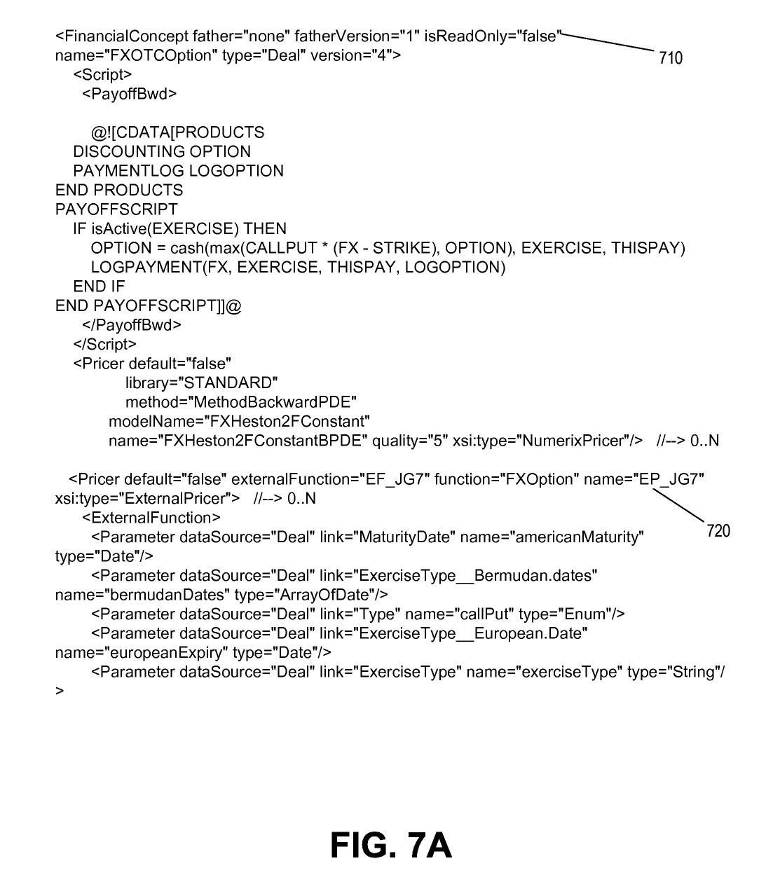

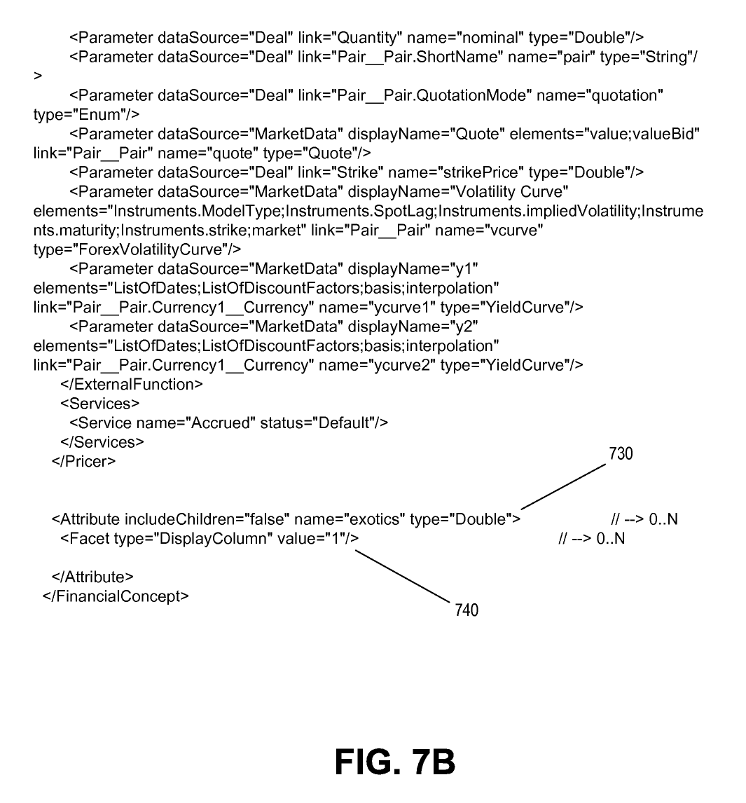

In step 202, after the user has completed his description of the new or modified financial product type in the product designer user interface, the information may be submitted to a product builder component. After the product builder component receives the new financial product type information in step 202; in step 203, the component may generate a markup language script based on the received product type information. As shown in FIG. 2, steps 203 and 204 may be executed after step 202, step 205, step 206, and/or step 207. Thus, in this example, steps 203 and 204 may be executed at different stages in the process, and also may be executed multiple times, during the design and implementation of a new financial product. For example, an extensible markup language (XML) script, such as the script of FIGS. 7A and 7B, may be generated and stored in meta language model 550 that defines a new financial concept (e.g., a structured product or other financial product type) within a set of <FinancialConcept> tags including different elements (i.e., sub-tags) and attributes within the XML script to define the characteristics and other properties of the new product type. For instance, the financial concept in this example may correspond to a barrier option product, and the generated XML script may include elements within the <FinancialConcept> tags defining the exercise date, strike price, and rebate associated with the barrier option. Additionally, these elements may have attached attributes specifying their behavior and specific properties, based on information received via the product designer user interface. When generating the markup script, it may be advantageous to include the complete definition of the financial product type within a single object (e.g., within a single set of XML tags), so that all of the information needed to create a deal based on that product type may be stored in a single location and may be easily transmitted between software components. Thus, any user-defined custom fields or reference to an inherited object may also be included in the markup language script. In certain examples, there may be six kinds of <FinancialConcept> objects: Products, blocks, schedules, schedule parameters, K+Blocks, and choices. (See definitions in Appendix D). Specifically, a payoff script for a deal may include payoff functions that invoke the financial methods and properties of the external financial libraries 330 and 340, in order to define the cash flow schedule and the financial reports for the deal. As described below in reference to FIG. 8, the product designer may include user interface controls to allow users to create and edit payoff scripts for the financial product types and deals displayed in the designer. Thus, when an XML script or other markup language script is generated in step 203, the associated payoff script for the deal may be embedded into the products script, for example, within separate XML payoff script sub-tags. In other examples, payoff scripts may be stored as separate text or script files, and the XML scripts generated for financial product types may include a payoff script property as an XML element or attribute that identifies and references the storage location of the product's payoff script.

In certain implementations, a specific variation of XML or a different markup language may be used for the structured product script. As an example, a customized trade scripting language may be implemented specifically to describe a set of structured product types, or to facilitate script-related tasks (e.g., generating scripts, validating and parsing scripts, registering structured product types) by the system software components.

In step 204, the markup language script created in step 203 is used to integrate the new financial product type into the financial management suite 360, to allow the creation of new deals based on the financial product type. As described in greater detail below in reference to FIG. 5, it may be advantageous to interpret the new product types and/or payoff scripts, rather than compiling source code for new financial product types as is done in traditional systems. For example, a Virtual Machine (530) installed at the product designer virtual platform 320 may have the ability to execute and debug financial product type and payoff scripts. In addition, the markup language script may be registered with the financial management suite 360, providing the suite 360 with the necessary product information and interface to instantiate and invoke the product when needed. Thus, a financial product markup script generated based on a user's interaction with the product designer user interface may be registered and instantiated quickly, without a traditional compilation and debugging processes, thus potentially allowing investors to more quickly perform analysis and other trading activities on newly created product type.

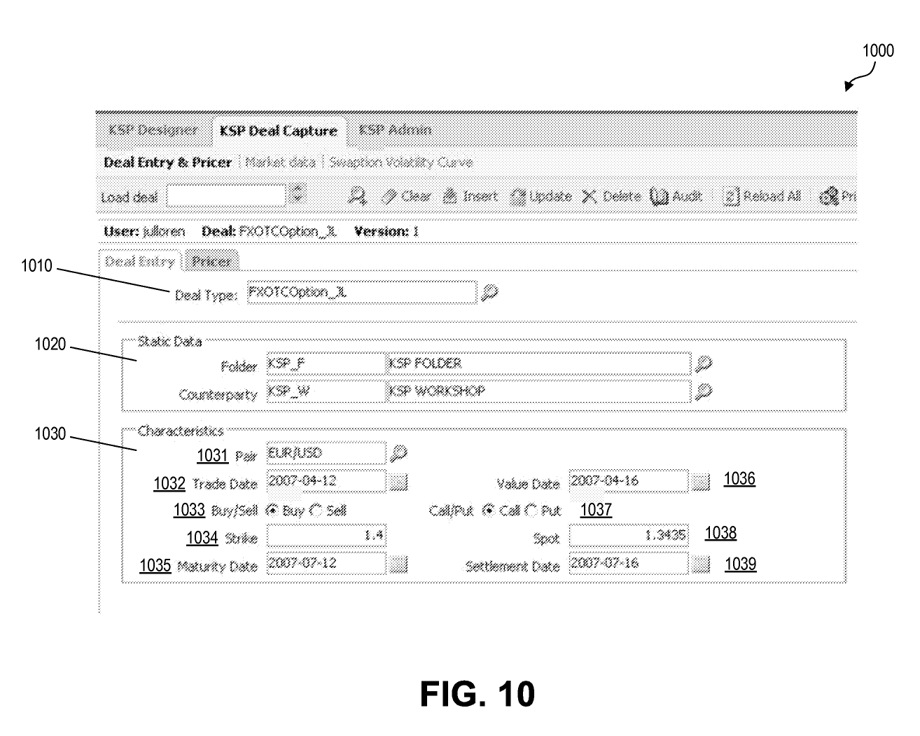

In step 205, after a new type of financial product is designed and implemented, a set of rules may be declared for the financial product type to define the workflow of the deal capture, for example, defining default values for new financial products created with the same type (e.g., use the deal capture user interface of FIG. 10). For example, a user may specify when implementing a new financial product type that by default the trade date characteristic for new financial products of that type is automatically set to the current date and the settlement date is automatically set to the trade date plus two working days. In this example, the trade date may be automatically set when the user captures the deal, and the settlement date may be recomputed when the trader modifies the trade date. The user may also compute the trade amount in different currencies, for example, by typing in the amount in dollars and using the system to compute the value in euros, or vise versa. In this example, if the user modifies the foreign exchange location, then the system may automatically compute the amount in the corresponding currencies of the exchange location. In these examples, a financial product designer or analyst may define a circular set of rules, such as:

PremiumCur 1=PremiumCur 2*FX Spot Rule 1

PremiumCur 2=PremiumCur 1/FX Spot Rule 2

In this example, the system may automatically detect and solve the dependencies between these two rules using the module rules engine 570. Thus, when the user modifies the foreign exchange Spot (FX Spot) value or the amount in foreign currency (PremiumCur2), the system may automatically compute the missing values by applying the above rules. In certain embodiments, the system may also be designed so as not to repeatedly (or indefinitely) loop when processing a circular set of rules, such as Rules 1 and 2 above. Additionally, in this example, the financial management system may propose or provide a proprietary script language to allow the user to define such rules and may allow the user to check the consistency of the rules and to inherit rules between different related financial product types.

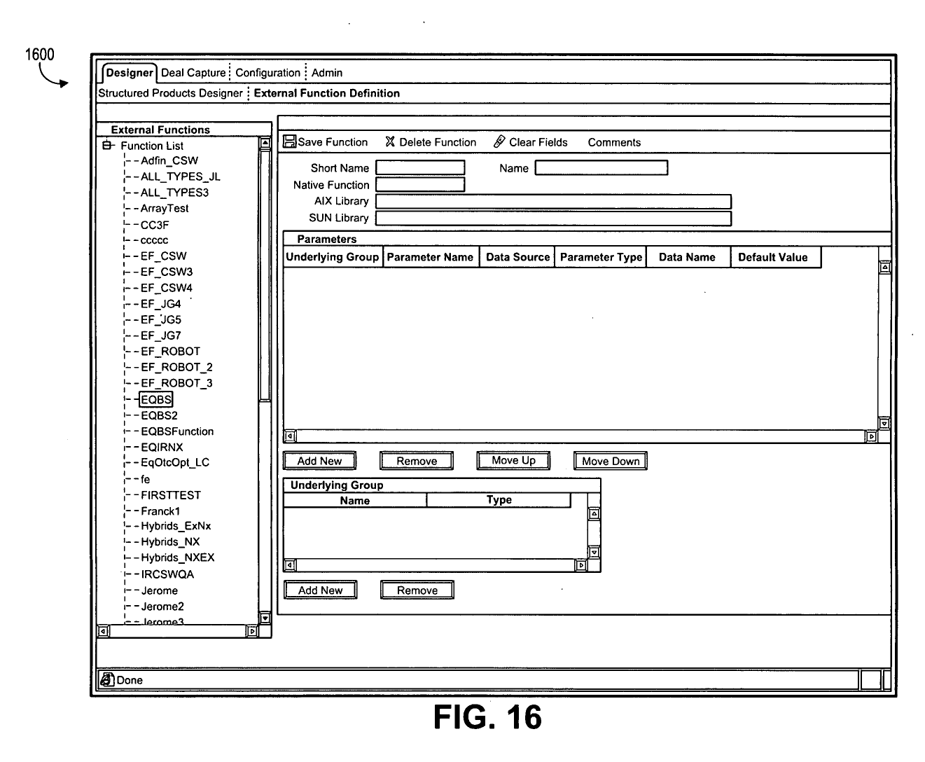

In step 206, after a new type of financial product is defined, a pricing model may be designated and a set of pricing model parameters may be defined so that the new product type may be used in deals, risk analysis, and other trading activities. For example, a user may select a set of predefined pricing models and methods, and/or an external pricing function to apply to the new financial product type. Depending on the type of the financial product, a wide variety of pricing models may be available. Before selecting a pricing model for the product type, external libraries of pricing models may be installed (e.g., downloaded) and made accessible to the financial management application. An illustrative list of pricing models and corresponding parameters is included in Appendix A, and a glossary of the pricing model parameters and their descriptions is provided in Appendix B. As shown in the table of Appendix A, the types and numbers of parameters may differ among different pricing models. Thus, the parameters available for a user to select/input for the new financial product may depend on the pricing model that is selected. In this example, if the user wants to use an external pricing function or function from the user's in-house libraries, the user may declare the header of the function within the system using an external library definition interface, for example, the illustrative user interface 1600 shown in FIG. 16.

In step 207, after the pricing model has been selected for the new financial product type, the user may define a payoff script of the product type. In certain examples, the user may describe the payoff function for a product type using the Numerix® scripting language. When using this or other scripting languages to define a payoff for a financial product, the financial management system may also provide the functionality to allow the user to check the script syntax during or after creation of the script. As another example, the user may use the Matlab® product engine to define external functions, and may use the Matlab® scripting language to define a pricing script for the external functions. Thus, it should be understood that the system and techniques disclosed herein are not limited to pricing new financial products with Numerix®. Although Numerix® may be embedded into the system in certain embodiments, the system may also be flexible enough to integrate all pricing libraries existing on the market using the module financial libraries 566.

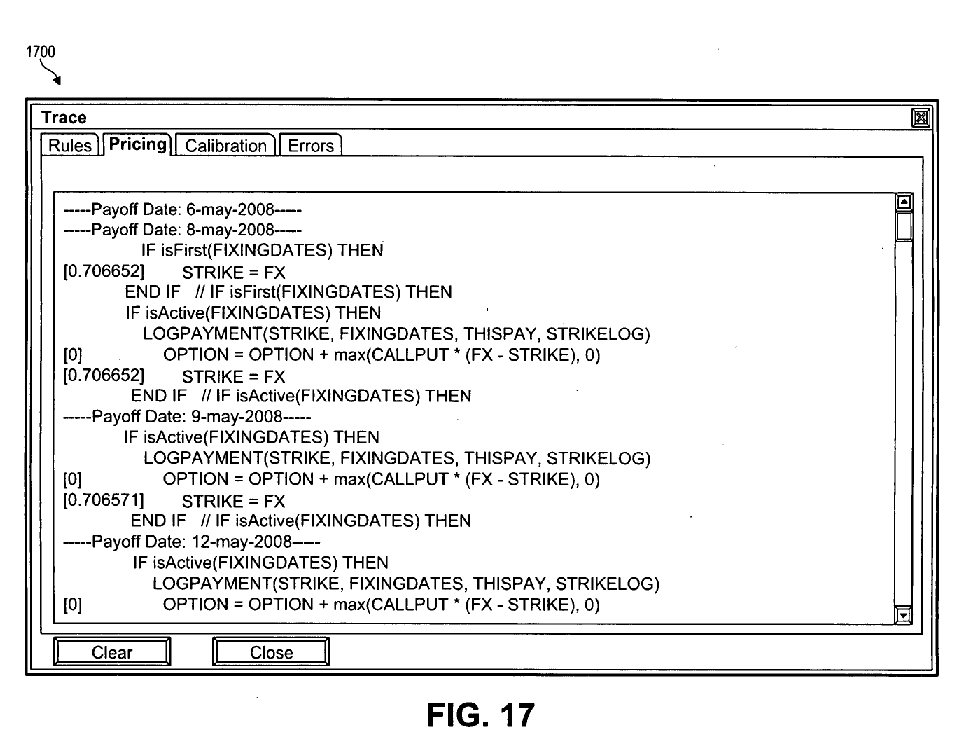

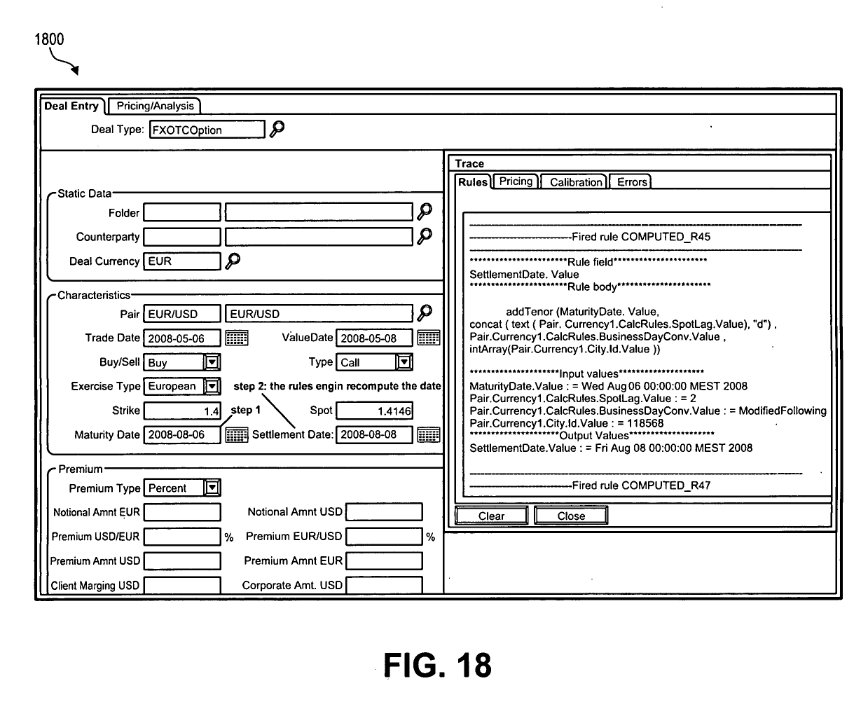

In step 208, the user may use the runner user interface 520 to create a new deal based on new type of financial product. To create a new deal, the user may first review the information on a capture screen displayed within the runner user interface 520 to confirm that the information for the new deal is correct. Specifically, the user may validate that the display of the deal capture interface matches the values the user has selected for the new deal (e.g., the label, position, and order of attributes), to confirm that these values are correct. Additionally, the user may confirm that the rules between fields are well executed using a local debugging tool, for example, using the illustrative tracing screens 1700-1800 shown in FIGS. 17-18. Thus, referring briefly to the user interface shown in FIG. 10, if the user modifies the trade date 1032 then the system may automatically compute the value date 1036. The user may review the user interface 1000 to confirm that default values are set correctly, for example, that the Buy/Sell field 1033 is set to “Buy”, and Call/Put field 1037 is set to “call”. In certain examples, the same user interface 520 may be used to select a pricing model and set pricing parameters (see steps 206-207) so that the user may confirm that the payoff script and the pricing model are correct for the new deal, for example, using the illustrative tracing screens shown in FIGS. 17-18. For instance, the layout of the runner user interface 520 may be dynamically updated after a user selects a pricing model, so that the correct data fields are provided to allow the user to set the parameters of the selected pricing model.

Once a new financial product, such as a derivative or structured product, has been created and priced, it may be used in a number of other operations supported by the financial management software application. For example, in step 208, a product designer or analyst may perform a risk management analysis involving the new financial product. The risk analysis done in the financial product suite 360 or financial suite interface 562 may be based on real or hypothetical market data, and may include a single financial product or a portfolio of multiple financial products. Then in step 208, a deal (e.g., purchase, sale) involving the financial product is defined, or captured, and may be executed by the financial management application (e.g., the financial product suite 360 or financial suite interface 562). The trading activities may involve both the newly created type of financial product and other types of financial products, such as products that were previously available for trading activities in the financial management application. It should be understood that each of the steps in this example is illustrative, and that these functions might be performed once, multiple times, or not at all, and in a different order or interspersed with other operations performed by the financial management application in order to create a functional financial product type that is front to back office integrated. That is, when a user creates a new type of financial product, the user may have to define all of the product characteristics, the payoff function, the pricing model, etc. The use may also define how to manage the back-office for the product and prepare all information needed by the back office system, such as deal termination and payout information. For example, some cash flows are computed by observing market rate at specific dates. This process is called fixing management and may require that the user defines one or more properties on the product attributes to indicate to the system how the fixing management should be done. In this example, if the user does not define the one or more properties on the product attributes to indicate how the fixing management should be done, then the system may be configured to do no fixing management.

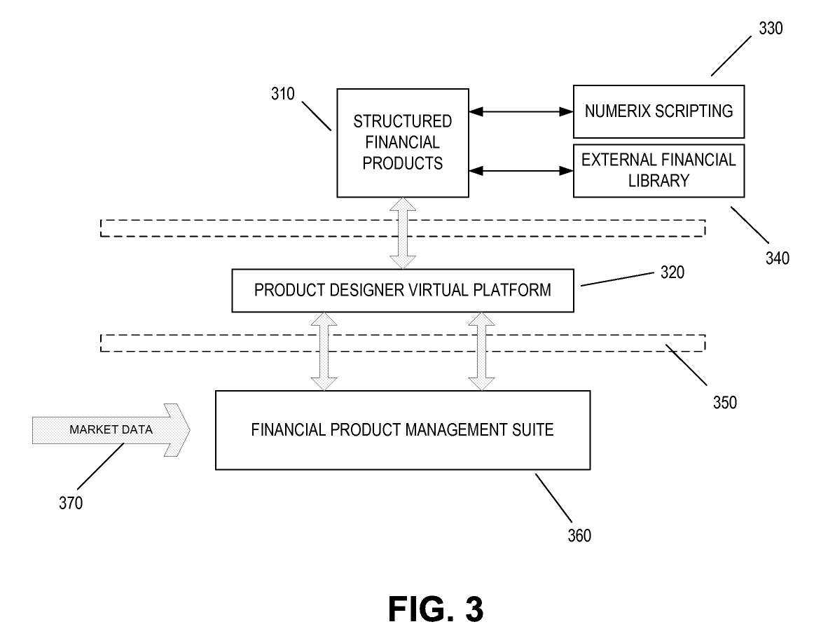

Referring to FIG. 3, a block diagram is shown illustrating software component interaction within a financial management system in accordance with aspects of the present invention. In this example, a library of structured financial products or derivatives 310 has been designed and implemented in the memory 115 of the computer system 101. The structured product library 310 may include products that were created and priced as described above in steps 201-202, and may include other products that were part of a pre-existing set of financial products made available by a financial services provider. The product designer virtual platform 320, described in detail below in reference to FIG. 5, is the component that allows users to design and implement new types of financial products (e.g., as described in steps 201-202) and allows the products in the library 310 to be integrated into the financial product management suite 360, so that the trading activities (e.g., as described in steps 203-204) may be performed on the structured products. Once a set of structured products 310 has been designed and implemented, these products may be priced using one or more financial libraries for pricing. For example, a NumeriX® scripting library 330 created and distributed by the NumeriX Corporation provides a pricing and risk analytics suite for structured financial products 310. Other external libraries 340, which may be script libraries (e.g., Matlab®), or non-script libraries (e.g., PPPro®), may provide similar pricing and financial analysis functionality for the structured products 310.

The financial product management suite 360 may be a standalone software application or web-based system supporting a broad range of financial operations such as trading (e.g., selling/buying callable swaption, target redemption swap, snowball, etc.), pricing, risk assessment and management using market data 370, and other financial portfolio management tasks. After the structured products 310 have been integrated into the financial product management suite 360, the operations supported by the suite 360 may be extended to each of the structured products 310, allowing investors to perform financial analysis and trading activities involving newly created products 310 in the same manner and with the same user interface as pre-existing financial products 310. Thus, the product designer virtual platform may allow users to dynamically extend the number of products managed by the financial product management suite.

Referring to FIG. 5, a block diagram is shown illustrating a configuration of software components that may interact to perform steps 201-208 implementing a new financial product type (e.g., structured product or derivative), in accordance with aspects of the present invention. It should be understood that FIG. 5 represents only one possible software architecture for performing certain aspects of the invention, and different configurations of software objects may be possible. In this example, the implementation of the virtual engine may be created in two parts; the first part may be implemented in JAVA, and the second part may be implemented in C++ for enhanced or quicker performance. During these steps, the user may go back and forth several times between the designer user interface 510 and the runner user interface 520. In certain examples, steps 201-207 may be performed using the designer user interface 510, while step 208 is performed using the runner user interface 520.

In this example, a builder user interface 510 includes a set of user interface components to allow a user (e.g., a product designer or analyst) to create, store, modify, and delete types of financial products, which may also be referred to as deal types. Thus, the builder user interface 510 may include some of the user interface controls, data fields, and other functionality described above in steps 201-205. For example, after a user creates or modifies a type of financial product and then saves the product type via the user interface 510, a new or revised markup language script may be automatically generated, for example, using a proprietary meta language model 550. In this example, the designer user interface 510 may be written in Java, or another scripting language, for easier product creation and script generation. For instance, the windows of the user interface 510 may be described in an XML file, while the controllers for the user interface components may be written in Java. The designer user interface 510 is connected to the builder engine 515 that manages the virtual engine 530. In this example, the virtual engine 530 comprises primarily three components: meta language model 550, the rules engine 570, and the data model component 540. The meta language model 550 allows the user to describe products, blocks, schedules, K+Blocks, market data, and choices (see Appendix D). The rules engine 570 may be used for the management of the workflow (i.e., on-screen behavior) of the deal capture and/or for all static data. Module 570 may compile rules into a non-procedural language and interpret the language when the user uses a deal capture. The data model component 540 in this example manages the storage of the definitions of new types of financial blocks using the versioning system 560. The data model 540 may also manage the storage of the deal using an audit trail. In certain embodiments, the system may track all modifications using the data model component 540.

Referring briefly to FIG. 6, an illustrative product designer user interface 600 is shown demonstrating some of the functionality of the builder user interface 510 described above. It should be understood that FIGS. 6, 8, 10, 11, 12, 16, 17, and 18 represent only one possible software interface for performing certain aspects of the invention, and different user interface software may be possible. In the example shown in FIG. 6, the product designer user interface 600 includes a list 610 of previously created types of financial products (e.g., deal types) and other financial building blocks (e.g., products, blocks, schedules, K+blocks, and choices). (See definitions in Appendix D). After the user selects a specific type of financial product, the product information window 620 is populated with the corresponding set of user interface controls and input data fields to describe the selected financial product type. In this example, the product information window 620 includes a tab control allowing users to view and update the product's characteristics, pricing model and functions, payoff scripts, and rules, all within the same user interface 600. When the characteristics tab is selected in the product information window 620, names of financial product types, lists of attributes 630 and properties 640 for the types of financial products, and other deal type characteristics are displayed allowing the user to add, edit, and delete deal type characteristics.

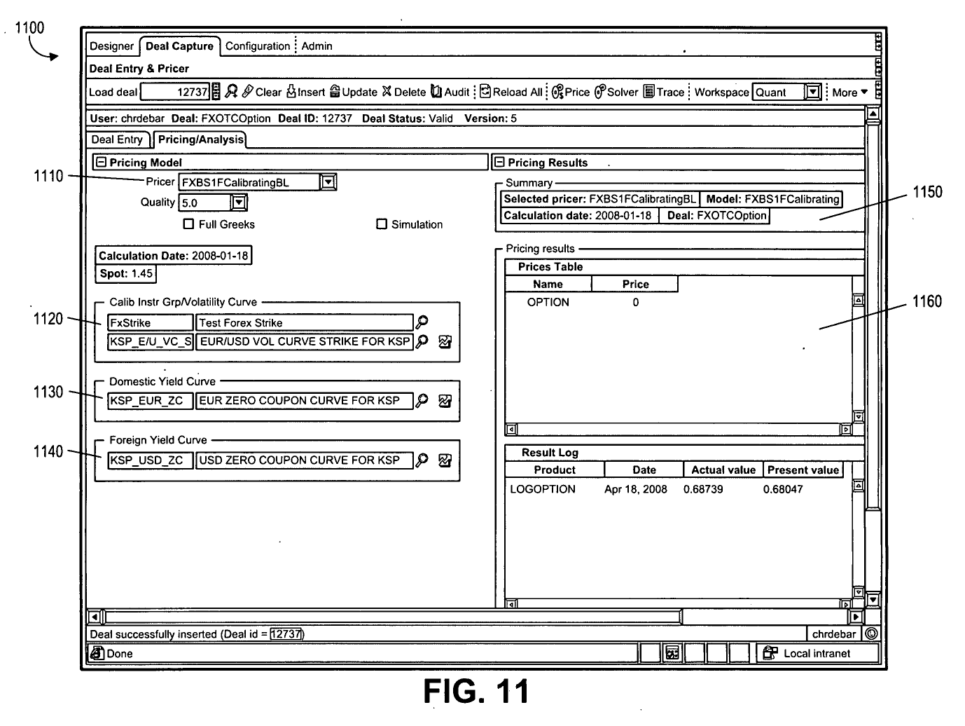

As discussed above, after the user describes/defines a new type of financial product, for example, using the product designer user interface 600, a new instance of a meta language script may be generated using meta language model 550. For instance, FIGS. 7A and 7B show a sample block of XML markup language that may correspond to a new type of financial product designed by a product designer or analyst using the financial management system. FIGS. 7A and 7B illustrate some of the properties and attributes that may be present in an XML script defining a new financial product type, or other block. In this example, the financial product type is defined between a set of <FinancialConcept> tags in the XML script. The opening <FinancialConcept> tag 710 may include parameters defining the name of the financial product type, and potentially the name and version of a parent type of financial product if the product inherits from another financial product type. In this example, the <Pricer> tag 720 is used to define the name and the associated method or external function for the pricing model, along with pricing model parameters. The set of parameters within the <Pricer> tag 720 may be used to define the items displayed in the menu 1110 in FIG. 11. The meta language script may also include one or more <Attribute> tags 730 that may be used to define the characteristics of the financial product type. Each attribute tag 730 may contain one or more <Facet> sub-tags 740 to define the behaviors of the attribute. For example, the “DisplayColumn” facet 740 stores and indication of which column that the attribute argument should be displayed within the designer and runner user interfaces 510 and 520.

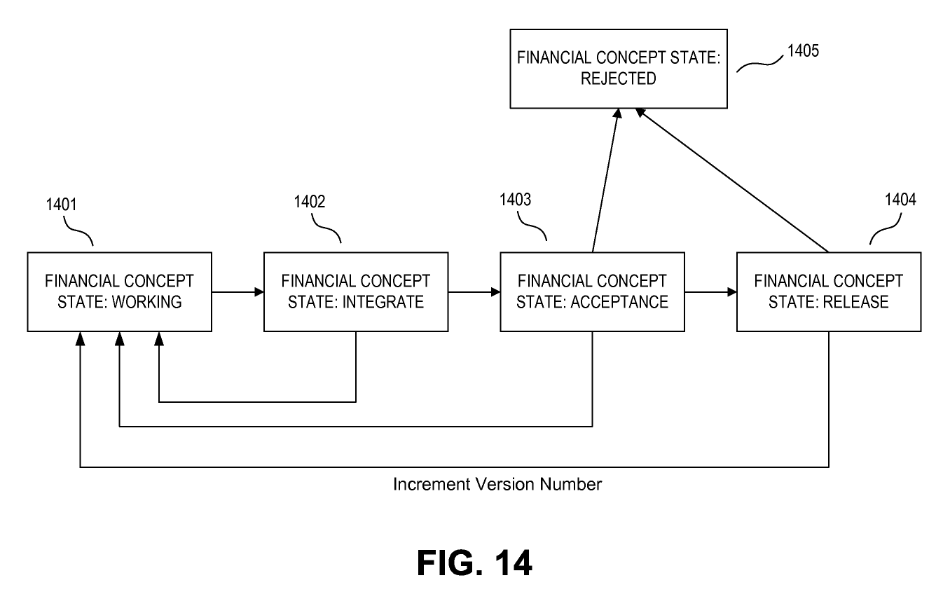

Returning to FIG. 5, after the user completes his interaction with the builder user interface 510 and saves (e.g., submits) the description for the new or modified type of financial product, the builder user interface 510 may generate and provide a corresponding markup language script to the builder engine component 515. In this example, the builder engine 515 is responsible for receiving and validating the markup language script describing the financial product type. The programming and implementation techniques of the builder engine 515 may be different from those of the builder user interface 510, because of the different set of functions performed by the two components. For instance, the builder engine 515 may be written in a higher-level language (e.g., Java or C++) and may be linked and implemented as a dynamic link library (DLL), to facilitate connections with the user interface 510, wrappers, libraries, and additional software components. Additionally, the engine 515 might not need to provide its own graphical user interface, and therefore might not realize many of the advantages of script languages (e.g., XML with Java controls). The markup language scripts received by the builder engine 515 may be XML scripts defining one or more financial products (e.g., structured products) so that each financial product type is separated within a different set of XML tags within the script. When the builder engine 515 receives a script, it may also verify the element names and property names within each financial product type in the script, and verify that the script format complies with XML standards. In certain implementations, communication between the user interface 510 and the builder engine 515 may be performed using a middleware framework and protocol, for example, the Tibco RendezVous (RDV) framework and protocol. After the new financial product type is generated and validated, it may be registered, by storing the XML script corresponding to the product type in a database or library (e.g., an in-house versioning repository 560). In this example, the repository 560 may support predefined functions for creating new XML files, checking in or out the XML files in the system 560, retrieving older versions of the XML files, and comparing different versions of the scripts/files stored in the system 560. Storage of a financial product type may include registering three separate meta language scripts in the repository 560: a script corresponding to the financial product type, a script corresponding to the designer user interface window used to create the product type, and a script corresponding to the runner user interface window that may be used to create a deal based on the type of financial product (discussed below). As discussed below in reference to FIG. 14, the life cycle of a financial product type may be managed by the repository 560 using a state engine to control a release process and to audit changes performed on the financial product type. Thus, FIG. 14 shows all of the authorized transitions of the state engine described in this example. However, it should be understood that in other examples, different sets of authorized transitions of the state engine may be available.

As mentioned above, the builder user interface 510 may be used to modify existing types of financial products, or to create new ones. Accordingly, the builder engine 515 may include functionality for storing, merging, and loading financial product type XML scripts into the builder user interface 510. For example, the builder engine 515 may retrieve from the repository 560 XML scripts corresponding to a financial product type and its associated builder user interface window. Then the builder engine 515 may load the scripts into the builder user interface 510, thereby customizing the user interface 510 to display the user interface components and input data fields defined in the financial product type, and populating the components and data fields with the values stored in the financial product type XML script.

The combination of the designer user interface 510 and builder engine 515 may provide additional features to allow users to more effectively manage financial product types. For example, the designer user interface 510 may be customized to allow users to define a payoff function and/or generate a payoff script, and to assist the user in validation of the payoff function variables. Referring briefly to FIG. 8, an illustrative product designer user interface 800 is shown allowing a user to define a payoff script for a type of financial product. In this example, the product designer user interface 800 includes the list 810 of available financial product types which may be selected by a user. After a financial product type is selected, the user may display the current set of scripts for the financial product type in an editable script window 820. The script window 820 may be used to create and edit payoff scripts, and additional features of the product designer interface 800 may allow for compilation and testing of the payoff script and automatic verification of the payoff script variables. The system may also check that all variables are correctly set, and may check the syntax and confirm that the attributes and/or variables in the script are linked correctly.

The designer user interface 510 and builder core 515 may also be used to assign an external pricing function to a type of financial product by customizing the designer user interface 510 to allow the user to declare a pricing function, arguments, and library, and then linking the identified pricing function and arguments to attributes defined in the meta language script corresponding to the product type. The designer user interface 510 and builder engine 515 may also support creation of custom and/or static data of any data type, and may allow the custom data to be updated or managed within these builder components 510-515. The builder components 510-515 may also allow users to export or import text file descriptions of financial product types, or to cut, copy, or paste definitions of financial product types into external applications. Additionally, the builder user interface 510 may allow users to display a hierarchy of multiple related product types (e.g., product types created with predefined inheritance relationships) in a sortable and groupable list form.

The runner user interface 520 includes a set of user interface components to allow a user (e.g., a product designer or analyst or a trader) to load, insert, update, price, solve or debug an instance of new types of financial products, which may also be referred to as deal. The runner engine 525 may perform actions by sending messages to virtual engine 530 via the runner user interface 520 such as, an instruction to load a set of products, interpret a selected product, generate a deal capture (See FIGS. 10, 12, 13), price the deal (See FIG. 11), insert a deal, load a deal, etc.

In the illustrative software component diagram of FIG. 5, the runner user interface 520 includes a set of user interface components that allow a user to create an instance of any of the types of financial products created by the builder components 510-515. An instance of a financial product type may also be referred to as a deal. The runner user interface 520 may provide the necessary data fields to allow a user to load and display a deal, and also to input the data defining a deal that may be created from one or more selected types of financial products. An illustrative list of mandatory attributes for deals and their descriptions is included in Appendix C. As another example, referring briefly to FIG. 10, a deal capture user interface 1000 is shown demonstrating some of the functionality described above in reference to the runner user interface 520. In the deal capture user interface 1000, a user may create a deal by first identifying a type of financial product in a text box or dropdown 1010, or in a similar user interface component, which may be populated from a stored list of financial product types in the repository 560 or other system storage. After selecting the financial product type from box 1010, a user interface may be automatically generated to allow the user to specify static data 1020, deal characteristics 1030, and other properties that may be stored with the deal in the financial management suite. In this example, the deal characteristics include pair 1031, trade date 1032, a buy or sell Boolean value 1033, strike price 1034, maturity date 1035, value date 1036, call or put Booleans 1037, spot price 1038, and settlement date 1039. Additionally, the deal characteristics and corresponding user interface fields may be dynamically updated in the user interface window 1000 in response to the financial product type selected by the user. An example of a rule that may be defined and associated with a financial product type may be described in reference to FIG. 10. For instance, if the user modifies the trade date 1032, a rule may dictate that the value date 1036 should be automatically computed and the default value of Buy/Sell Boolean value 1033 should be automatically set to Buy.

The runner user interface 520 in FIG. 5 may be written in a scripting language and may occupy the same user interface window(s) as the designer user interface 510, described above. Thus, the windows of the runner user interface 520 may also be described in an meta language file (e.g., XML), and the controllers for the runner user interface components may be written in Java. The runner user interface 520 may also include a script debugger and event simulator to allow users to more easily build and test deals.

The runner user interface 520 in this example may communicate with a runner engine component 525 to load a specific deal, insert a deal and to modify a deal with a financial product management suite via interface 562. In this example, the financial suite interface 562 may connect to a Reuters Kondor+ suite for deal capturing, position keeping, and pricing. The runner engine 525 may be responsible for managing the association between the type and version of the type of financial product and the deal inserted. Thus, when the runner engine 525 loads a deal, it may be able to load the correct version of the corresponding financial product type accordingly. Like the builder engine 515, the runner engine 525 may be written in Java or C++ and linked as a DLL to facilitate connections with the other software components. The runner engine 525 may also support simulation and debugging of script execution by providing an interface to access the engine core component (e.g., virtual engine 530). As with the builder components 510-515, the communication between the runner user interface 520 and the runner engine 525 may be performed using a middleware framework and protocol.

The combination of the runner user interface 520 and engine 525 may provide additional features for creating and performing functions involving deals. As described above in reference to FIG. 10, the runner user interface 520 may provide a selectable list of financial product types retrieved from the repository 560, then receive a user selection of a product type from the list for creating a new deal. The user may then use the runner user interface 520 to fill in all of the characteristics of the deal and to insert the deal into the database via the financial suite interface 562 and store the corresponding version of the selected financial product type. For deleting or modifying deals, the runner user interface 520 may provide a second list of previously created deals retrieved from the financial suite interface 562 and retrieve their descriptions from versioning system 560. The runner components 520-525 may also generate a deal screen (e.g., user interface screen 1000 in FIG. 10) and populate the screen 1000 with the deal data and characteristics. Through the deal screen 1000 users may also modify and update the deal into the product/deal management suite. The user can also define constraints using rules to specify, for example, that the maturity date does not fall on a holiday, or that the settlement date is greater than the trade date, etc. In certain implementations, the runner components 520-525 may allow users to generate and view reports for deals using a gap analysis, financial or global hedging analysis, and cash flow reporting. The runner components 520-525 may also support market data assignation into the deal, deal pricing, and deal test pricing using one or more market scenarios. For example, in FIG. 11 a deal pricing user interface 1100 is shown, allowing a user to price a deal following the deal capture phase. In this user interface 1100, a list of pricing models compatible with the deal may be retrieved based on the financial product type (e.g., by retrieving the sub-tags and parameters for the <pricer> tag 720 in the product type XML description), and the pricing models may be used to populate a dropdown 1110. See Appendices A and B for an illustrative pricing model list and glossary that may apply for certain financial product types and deals. After the user selects a pricing model, the parameters for the selected pricing model may be retrieved from the pricing model library and corresponding user interface controls 1120-1140 may be positioned on the user interface 1100.

Returning to FIG. 11, the pricing model selected in this example (shown in dropdown 1110) has at least parameters corresponding to the volatility curve 1120, domestic yield curve 1130, and foreign yield curve 1140. Thus, these parameters are displayed on the user interface window, and the values selected for these parameters may be stored in the markup language script associated with the deal. In this example, after the user has assigned or updated these parameter values 1120-1140, the pricing summary 1150 and pricing results 1160 fields may be calculated and displayed on the user interface 1100.

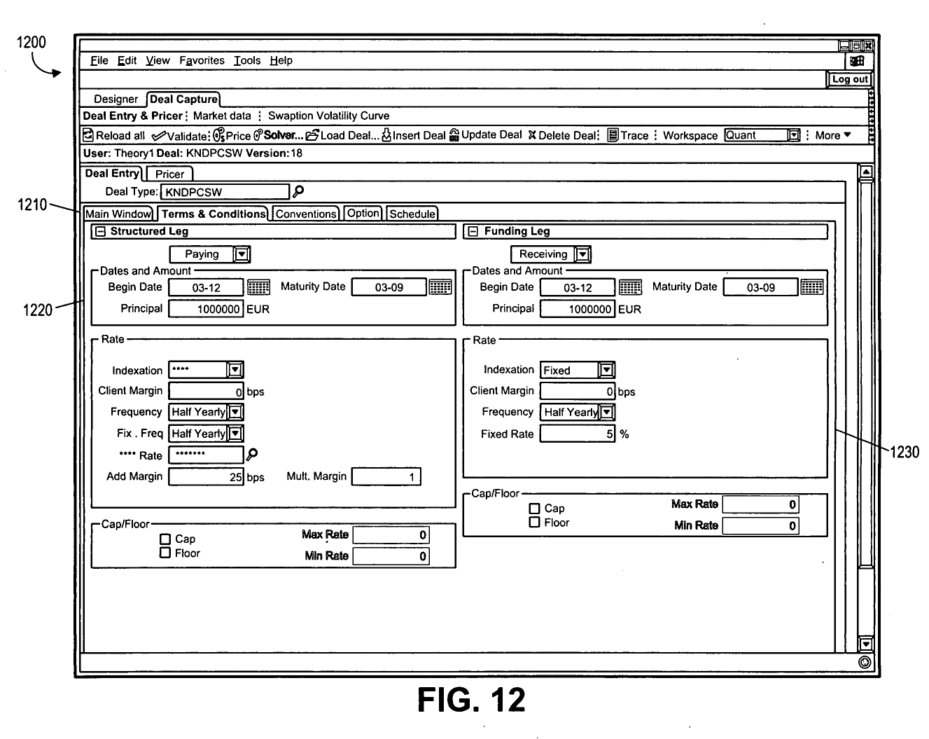

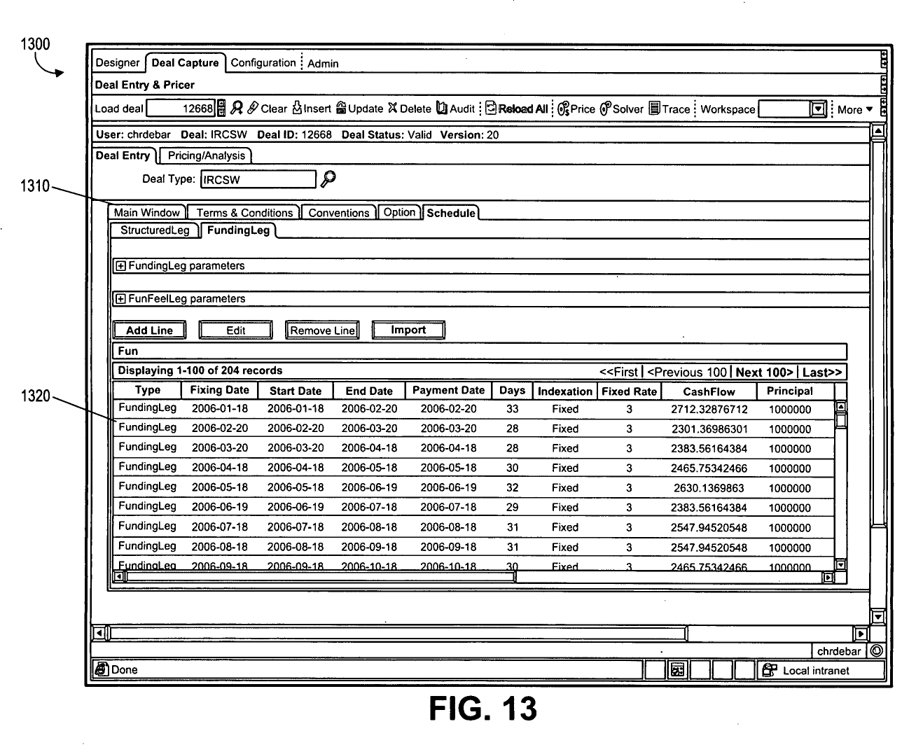

After a deal has been captured, the complete results of the deal capture may be viewed in the runner user interface 520. As another example, FIG. 12 shows an illustrative screenshot of a deal capture user interface 1200 for a multi-leg deal. In this example, the user is provided a tab control 1210 for viewing different types of information associated with the deal capture. When the ‘Terms & Conditions’ tab is selected, the deal details for the structured leg 1220 and the funding leg 1230 are displayed in different regions of the screen by dynamically populating the user interface 1200 with the requested data fields and corresponding values for the deal. Similarly, in FIG. 13, a related illustrative screenshot of a deal capture user interface 1300 is shown, in which the ‘Schedule’ tab from the results tab control 1310 is selected. In this example, after the ‘Schedule’ tab is selected, the cash flow schedules for the captured deal are shown in region 1320.

Returning to FIG. 5, the virtual engine component 530 may receive captured deals and/or deal events via the financial suite interface 562, in order to perform actions on deals. For example, the virtual engine 530 may receive a ‘living’ deal and pricing event from the financial suite via interface 562, and then launch a set of functions on the deal to get the profit and loss for the deal, compute the risk indicators for the deal, compute the accrued interest, compute the market values, and get the cashflow list for the deal. When performing functions on deals, the virtual engine 530 may require access to mathematic and/or financial functions from a financial library 566 (e.g., a NumeriX® scripting library, a MatLab® scripting library, or an external financial library), as well as static and market data from the financial suite interface 562. Upon completion of the events, the virtual engine 530 may modify the deal and return the deal to the financial suite via interface 562. For example, when the user launch reports from the financial suite interface 562, the interface 562 may call the virtual engine core 530 to get prices for a set of deals and display the results in the report.

In this example, the virtual engine 530 may be designed and implemented in C++, since compatibility with Java might not be necessary, and it may be advantageous to have the virtual engine 530 execute quickly and with process stability for long periods of time. Since many of the functions invoked by the virtual engine 530 may be require significant running time (e.g., execution of pricing functions for a deal), the virtual engine 530 may perform external functions via one or more forked executables, and may be configured to handle any potential load balancing problems between the executables.

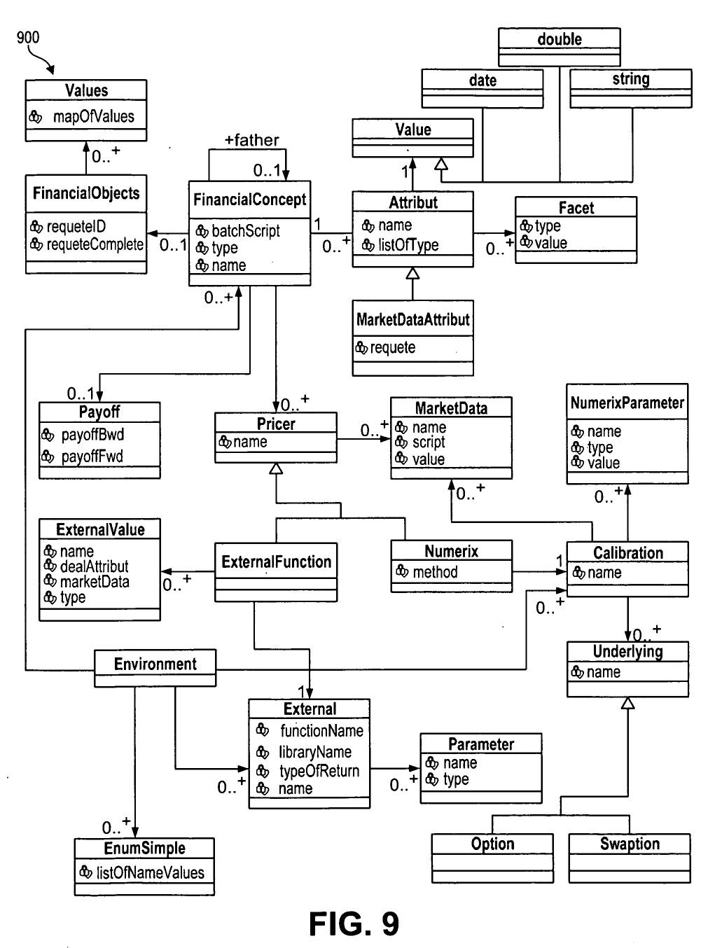

The data model 540, meta language 550, and rules engine 570 may represent additional data components that are available to the builder engine 515 and the runner engine 525 via the virtual engine 530. For example, a financial product type may be represented by a combination of the data model 540 to control database storage, meta language model 550 to define the financial product type, and the rules engine 570 to define the behaviors of the deal capture. The data model 540 may include a set of XML schema definition files stored on the system allowing the other components to fully describe any supported financial product type. Thus, data model 540 may include an XML schema with complete descriptions of the financial product types and captured deals, allowing the other software components to create a deal based on a product type, create a valid XML script describing a new type of financial product, create a product type from a valid XML script, and create a deal from a valid XML script describing a financial product type. Referring briefly to FIG. 9, an illustrative schema 900 is shown for the meta language component 550. In this example, schema 900 represents a possible implementation of the meta language model 550. The meta language model 550 allows the user to describe a financial building block as a set of attributes and a set of facets (or properties) for each attribute. (See Appendix D). Financial building blocks, like product types, may inherit from other building blocks. For example, a building block A may be defined by two attributes. If financial building block B inherits from block A, then block B will also be defined by the same two attributes. In this example, block B may be able to overload an inherited attribute by changing its type or set of facets for the inherited attribute.

The meta language model 550 may contain one or more language definitions capable of describing actions that may be performed on a deal. For example, the language described in Table 1 below may correspond to a simplified version of the Visual Basic programming language. This illustrative language definition may be stored in the language model 550, and may then be used to describe rules in the system.

TABLE 1
Basic Language Definition for Defining Rules

| | |
|---|---|
| Variable | IF (condition) THEN expression [ELSE |
| Tests | expression]* ENDIF |
| Numerical | ABS (numeric), POW(numeric, numeric), |
| Expressions | SQRT(numeric), EXP(numeric), LOG |
| | (numeric), MIN(numeric, numeric), |
| | MAX(numeric, numeric), +, −, /, *, (,), |
| | SIG(numeric), STEP(numeric) |
| Conditions | AND, OR, XOR, TRUE, FALSE, =, <, > |
| Arrays | variant array |
| Predefined | Day( ) + Financial operation |
| Functions | Day Shifters |
| SQL | connect, query, fetch array, affected rows, |
| | disconnect |

Additionally, the language in this example, or other languages defined in the meta language model 550 may have interpreters to allow language scripts to be executed and/or debugged. This language and other languages may also be used to define rules pay-off functions of deals (see 820, FIG. 8).

As discussed above in reference to step 201 of FIG. 2, a set of rules may be declared for a new financial product type during or after implementation of the new type. These rules, for example, rules defining default values and behaviors for financial product types by manipulating fields within the user interfaces 510 and 520, may be implemented using the rules engine 570 within the virtual engine 530. In this example, the rules engine 570 may comprise two different main modules: a translator module and an engine module. The translator module may receive, validate, and translate the rules expression(s) entered via the designer user interface 510 into rules files. For example, the translator module may be invoked by the virtual engine 530 when a user types a formula into the field rules editor within the appropriate screen of the designer user interface 510.

The rules engine 570 may also comprise an engine module that controls the firing of rules generated by the translator module from the runner user interface 520. For example, when a user modifies an attribute of the deal via the user interface (e.g., user interface 1000 of FIG. 10) and the attribute has a defined rule that is triggered when the value of the attribute is modified.

The rules engine 570 may also manage the priorities of rules stored in the memory of the engine 570. In some examples, the system might not be able to solve the problem of conflicting rules/events or order of execution, and thus the user may add a priority or salience to a rule. For instance, a user could indicate which of many different rules must be fired when the rule triggering conditions are satisfied. Thus, for example, each rule may have a salience that can be assigned as an integer, defaulting to zero, but which can be negative or positive. Salience is a form of priority in which rules with higher salience values are given higher priority. When a salience conflict occurs, (e.g., when more than one rule has the same salience value for the current cycle of rules execution), the rules engine component 570 may be designed to resolve the identified conflict.

As the rules engine 570 manages the different conditions and priorities of the rules within its domain, it may encounter and handle several different types, or classes, of rules. For example, a constraint rule may be used to define whether or not an attribute is visible, or active. In this example, the user may define a logical expression or predicate that represents the condition, and the system may propose a constraint to be used for validation of the deal. Thus, the user may define a predicate to be checked by the system before deal insertion. For instance, the predicate may cause the system to verify that the maturity date is greater than the trade date, or may cause the system to verify that the barrier up is greater than the barrier down before deal insertion.

Computed rules are another type of rule that may be supported by the rules engine 570. Computed rules may include a computed expression that is stored within the user interface 510 and then used to calculate a field value within the user interface 520 based on values from other fields or components within those user interfaces. For example, a user-created rule may compute the amount of the deal in different currencies. In this example, after the user types in the deal amount in dollars, the system may compute and display the value in Euros, and vise versa. If the user modifies the foreign exchange spot, then the system will automatically compute the amount in the appropriate currency.

Yet another type of rule, referred to meta rules, that may be managed by the rules engine 570 relates to the set of assumptions that determine the order of rule firing. The rules engine 570 may use meta rules to identify/retrieve all of the rules that may possibly be fired, and then select which rules to fire. For example, the illustrative set of meta rules described in Table 2 below may be imposed by the financial management system to order and organize the firing of all user-created or default rules on the system. In certain embodiments, a pre-defined set of meta rules, such as those in Table 2 below, are embedded into the system and cannot be modified by the user.

TABLE 2
Illustrative Set of Meta Rules Imposed By the Rules Engine

| | |
|---|---|
| Meta Rule 1 | Under Meta Rule 1, the rules engine 570 |
| | controls the user interface components so |
| | that there is one and only one attribute |
| | modification done by the user using runner |
| | user interface 520 before each cycle of |
| | rules execution in the virtual engine 530. |
| Meta Rule 2 | Under Meta Rule 2, a rule may be fired |
| | only if all its premises have been either |
| | changed by the user or calculated within |
| | the previous cycle of rule execution. That |
| | is, |
| Meta Rule 3 | Under Meta Rule 3, a rule cannot be fired |
| | if its consequences modify the last input |
| | field value by the user. Thus, using this |
| | rule, the system protects values input by |
| | the user using the runner user interface |
| | 520. |
| Meta Rule 4 | Under Meta Rule 4, in one cycle, a premise |
| | contained in a fired rule cannot be |
| | modified anymore. |
| Meta Rule 5 | Under Meta Rule 5, when the rules engine |
| | 570 has the choice between executing two |
| | rules, it applies the priorities of the first |
| | modified value. For instance, with the |
| | following set of rules and actions: |
| | Rules: |
| | R1: D ← A, B |
| | R2: D ← B, C |
| | Actions: |
| | A change → { } |
| | C change → { } |
| | B change → |
| | In this example, without Meta Rule 5, it |
| | cannot be determined which rule will fire |
| | because both R1 and R2 modify D. Thus, |
| | Meta Rule 5 is applied so that the engine |
| | will select the rule with the higher priority. |

Referring to FIG. 14, a state diagram is shown illustrating different possible stages in a life cycle of a financial product type. In this example, the versioning system 560, may control the flow of financial products types throughout the development cycle from an original version of a product type (step 1401) through the testing and release stages 1402-1404 and/or a possible rejection stage 1405 for the product type. The financial management system may track the evolution of the financial product types and manage the repository 560 that contains versions of all financial product types existing on the system. In this example, an audit trail is used so that all changes are tracked on logged within the system. During the working stage 1401, financial building blocks (e.g., financial product types) may be created, designed, and associated with a defined pricing model, rules, event management and workflow automation. In this example, these financial building blocks may be visible to the owner only, so that other product designers cannot see and are not impacted by modification done to the blocks during the working stage. In the integration stage 1402, the financial building blocks may then be tested for integration with other the building blocks/financial product types in the repository 560. In the acceptance stage 1403, the new building blocks may be published to other product designers and/or analysts, and in the release stage 1404, the new building blocks/financial product types may be published to financial traders for trading. If the new financial building blocks fail the acceptance or release stages, they may be withdrawn from the repository 560 as part of the rejection stage 1405. The potential advantages of this multi-stage integration example may include facilitating interactions by users in different roles (e.g., product designers, analysts, traders) and allowing these users to operate continuously under a constantly changing knowledge base and set of financial product types and deals.

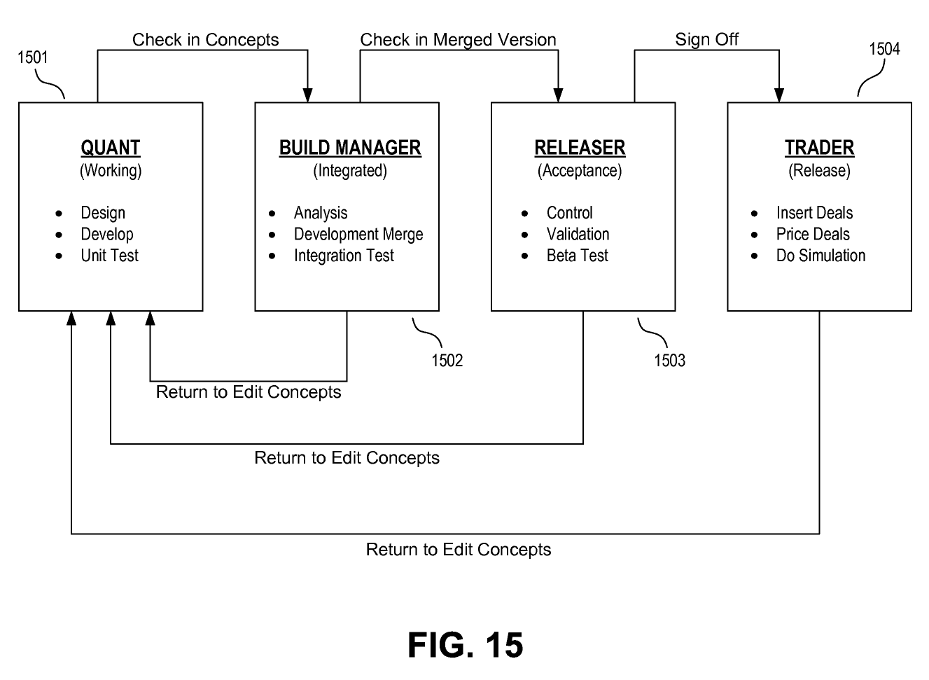

Referring to FIG. 15, a flow diagram is shown illustrating certain user roles and associated responsibilities that may operate within the financial management system, and illustrating relationships between those user roles. In this example, four different types of users are described according to their typically interactions with the financial management system. The quantitative analysis personnel (or “quant”) 1501 may design new financial product types (e.g., in the working stage 1401 of the financial product type life cycle shown in FIG. 14). In this example, the quant 1501 may have access to all financial product types and deals within the financial management system, regardless of the state (i.e., stage 1401 to 1404) of the financial product type.

After the initial development stage is complete, the quant 1501 may present the new (or modified) financial product type to a workspace build manager 1502 and send the product type to the integrate stage 1402. The workspace build manager 1502 may ensure that all tests have been completed successfully, and may then integrate the new financial product type into the system (e.g., by merging the new or modified product type into the repository 560 and performing basic integration tests on the integrated repository 560). In this example, the workspace build manager 1502 may have access to the financial product types in the stages of integrate 1402, acceptance 1403, or release 1404, but might not have access to financial product types in the working stage 1401.

Depending on the results of the integration tests, the workspace build manager 1502 may set the product type to the acceptance state (stage 1403) and present it to a product releaser 1503, or he may reject the financial product type and return it to the quant 1501. The releaser 1503 may validate the financial product type after testing and make the product type usable to traders 1504 by putting it into the release state (stage 1404). If the financial product types fail testing at the acceptance stage 1403, the releaser 1503 may also return the financial product types to the quant 1501. In this example, the releaser 1503 may have access to the financial product types in the stages of acceptance 1403 or release 1404, but not integrate 1402 or working 1401. Similarly, the trader 1504 in this example might only have access to the financial product types in the release stage 1404, and not to product types/concepts in any other stage of development. Thus, the architecture and role defined in this example may prevent traders 1504 from creating or modifying any financial product types or other financial concepts, restricting those functions to other more appropriate personnel (e.g., quants 1501). Additionally, the financial management system may have functionality in place to track the actions or steps taken by each of the users at each stage described above and illustrated in FIG. 15.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It will also be appreciated and understood that modifications may be made without departing from the true spirit and scope of the present invention. The description is thus to be regarded as illustrative instead of restrictive on the present invention.

### APPENDIX A

### Pricing Models and Parameters

| Pricing Model | Parameters |
|---|---|
| EQBS1FCalibrating | Reference Date |
| | Spot |
| | Calibration Instruments |
| | Group/Volatility Curve |
| | Domestic Yield Curve |
| FXHeston2FConstant | Reference Date |
| | Spot |
| | Lambda |
| | Xi |
| | Rho |
| | Theta |
| | Alpha |
| | Beta |
| | VolSquare0 |
| | Calibration Instruments |
| | Group/Volatility Curve |
| | Domestic Yield Curve |
| | Foreign Yield Curve |
| IRBDT1FCalibrating | Now Date |
| | Calibration Instruments |
| | Group/Volatility Curve |
| | Yield Curve |
| IRHW2FCalibrating | Now Date |
| | Max Mean Reversion |
| | Time Dependent |
| | Calibration Instruments |
| | Group/Volatility Curve |
| | Yield Curve |
| FXDupire1FCalibrating | Reference Date |
| | Spot |
| | Calibration Instruments |
| | Group/Volatility Curve |
| | Domestic Yield Curve |
| | Foreign Yield Curve |
| FXBS1FCalibrating | Reference Date |
| | Spot |
| | Calibration Instruments |
| | Group/Volatility Curve |
| | Domestic Yield Curve |
| | Foreign Yield Curve |
| EQHagan2FConstant | Reference Date |
| | Spot |
| | Lambda |
| | Xi |
| | Rho |
| | Beta |
| | Vol0 |
| | Calibration Instruments |
| | Group/Volatility Curve |
| | Domestic Yield Curve |
| FXHagan2FATMCalibrating | Reference Date |
| | Spot |
| | Lambda Max |
| | Xi Max |
| | Rho Max |
| | Beta Min |
| | Beta Max |
| | Vol ATM |
| | Maturity Date |
| | Calibration Instruments |
| | Group/Volatility Curve |
| | Domestic Yield Curve |
| | Foreign Yield Curve |
| EQHagan2FATMCalibrating | Reference Date |
| | Spot |
| | Lambda Max |
| | Xi Max |
| | Rho Max |
| | Beta Min |
| | Beta Max |
| | Vol ATM |
| | Maturity Date |
| | Calibration Instruments |
| | Group/Volatility Curve |
| | Domestic Yield Curve |
| IRHW2FReversionCalibrating | Now Date |
| | Mean Reversion 1 |
| | Mean Reversion 2 |
| | Rho12 |
| | Calibration Instruments |
| | Group/Volatility Curve |
| EQHagan2FATMConstant | Reference Date |
| | Spot |
| | Lambda |
| | Xi |
| | Rho |
| | Beta |
| | Vol ATM |
| | Maturity Date |
| | Calibration Instruments |
| | Group/Volatility Curve |
| | Domestic Yield Curve |
| EQHeston2FReversionCalibrating | Reference Date |
| | Spot |
| | Lambda |
| | Calibration Instruments |
| | Group/Volatility Curve |
| | Domestic Yield Curve |
| FXHagan2FATMConstant | Reference Date |
| | Spot |
| | Lambda |
| | Xi |
| | Rho |
| | Beta |
| | Vol ATM |
| | Maturity Date |
| | Calibration Instruments |
| | Group/Volatility Curve |
| | Domestic Yield Curve |
| | Foreign Yield Curve |
| FXHagan2FCalibrating | Reference Date |
| | Spot |
| | Lambda Max |
| | Xi Max |
| | Rho Max |
| | Beta Min |
| | Beta Max |
| | Vol Max |
| | Maturity Date |
| | Calibration Instruments |
| | Group/Volatility Curve |
| | Domestic Yield Curve |
| | Foreign Yield Curve |
| IRHW1FReversionCalibrating | Now Date |
| | Mean Reversion |
| | Calibration Instruments |
| | Group/Volatility Curve |
| | Yield Curve |
| IRHW3FReversionCalibrating | Now Date |
| | Mean Reversion 1 |
| | Mean Reversion 2 |
| | Mean Reversion 3 |
| | Rho12 |
| | Rho13 |
| | Rho23 |
| | Calibration Instruments |
| | Group/Volatility Curve |
| | Yield Curve |
| EQHeston2FCalibrating | Reference Date |
| | Spot |
| | Calibration Instruments |
| | Group/Volatility Curve |
| | Domestic Yield Curve |
| IRHW1FCalibrating | Now Date |
| | Max Mean Reversion |
| | Nb Points |
| | Tolerance |
| | Calibration Instruments |
| | Group/Volatility Curve |
| | Yield Curve |
| IRSpotSkew1FCalibrating | Now Date |
| | Max Date |
| | Calibrate Mean Reversion |
| | Skew |
| | Mean Reversion |
| | Calibration Instruments |
| | Group/Volatility Curve |
| | Yield Curve |
| FXHeston2FCalibrating | Reference Date |
| | Spot |
| | Calibration Instruments |
| | Group/Volatility Curve |
| | Domestic Yield Curve |
| | Foreign Yield Curve |
| IRBK1FCalibrating | Now Date |
| | Max Date |
| | Calibrate Mean Reversion |
| | Mean Reversion |
| | Calibration Instruments |
| | Group/Volatility Curve |
| | Yield Curve |
| FXHagan2FATMCalibrating | Reference Date |
| | Spot |
| | Lambda Max |
| | Xi Max |
| | Rho Max |
| | Beta Min |
| | Beta Max |
| | Vol ATM |
| | Maturity Date |
| | Calibration Instruments |
| | Group/Volatility Curve |
| | Domestic Yield Curve |
| | Foreign Yield Curve |
| EQHeston2FConstant | Reference Date |
| | Spot |
| | Lambda |
| | Xi |
| | Rho |
| | Alpha |
| | Theta |
| | Beta |
| | VolSquare0 |
| | Calibration Instruments |
| | Group/Volatility Curve |
| | Domestic Yield Curve |
| | Foreign Yield Curve |
| EQDupire1FCalibrating | Reference Date |
| | Spot |
| | Calibration Instruments |
| | Group/Volatility Curve |
| | Domestic Yield Curve |
| FXHeston2FReversionCalibrating | Reference Date |
| | Spot |
| | Lambda |
| | Calibration Instruments |
| | Group/Volatility Curve |
| | Domestic Yield Curve |
| | Foreign Yield Curve |
| FXHagan2FConstant | Reference Date |
| | Spot |
| | Lambda |
| | Xi |
| | Rho |
| | Beta |
| | Vol0 |
| | Calibration Instruments |
| | Group/Volatility Curve |
| | Domestic Yield Curve |
| | Foreign Yield Curve |
| IRHW3FCalibrating | Now Date |
| | Max Mean Reversion |
| | Max HW Volatility |
| | Time Dependent |
| | Calibration Instruments |
| | Group/Volatility Curve |
| | Yield Curve |
| EQHagan2FCalibrating | Reference Date |
| | Spot |
| | Lambda Max |
| | Xi Max |
| | Rho Max |
| | Beta Min |
| | Beta Max |
| | Vol Max |
| | Maturity Date |
| | Calibration Instruments |
| | Group/Volatility Curve |
| | Domestic Yield Curve |
| EQQuantoBS | EQBS |
| | Reference Date |
| | Spot |
| | Calibration Instruments |
| | Group/Volatility Curve |
| | Domestic Yield Curve |
| | FXBS |
| | Reference Date |
| | Spot |
| | Calibration Instruments |
| | Group/Volatility Curve |
| | Domestic Yield Curve |
| | Foreign Yield Curve |
| | Quanto |
| | Correlation |
| EQIRBSHWCalibrating | EQBS |
| | Reference Date |
| | Spot |
| | Calibration Instruments |
| | Group/Volatility Curve |
| | Domestic Yield Curve |
| | IRHWCalibrating |
| | Now Date |
| | Max Mean Reversion |
| | Nb Points |
| | Tolerance |
| | Calibration Instruments |
| | Group/Volatility Curve |
| | Yield Curve |
| | EQ-IR |
| | Correlation |
| EQIRBSHWReversionCalibrating | EQBS |
| | Reference Date |
| | Spot |
| | Calibration Instruments |
| | Group/Volatility Curve |
| | Domestic Yield Curve |
| | IRHWReversionCalibrating |
| | Now Date |
| | Mean Reversion |
| | Calibration Instruments |
| | Group/Volatility Curve |
| | Yield Curve |
| | EQ-IR |
| | Correlation |

### APPENDIX B

### Glossary of Pricing Model Parameters

Alpha—A measure of the difference between a portfolio's actual returns and its expected performance, given its level of risk as measured by beta. A positive alpha figure indicates the portfolio has performed better than its beta would predict. In contrast, a negative alpha indicates the fund's under performance, given the expectations established by the fund's beta. Alpha takes into account the volatility of a particular portfolio and matches the risk-adjusted performance of that portfolio against a benchmark index.

Beta—A measure of a fund's volatility relative to the market. A beta of greater than one indicates that the fund is more volatile than the market, and less than one is less volatile than the market.

Beta Max—Maximum value of beta.

Beta Min—Minimum value of beta.

Calibrate Skew—Whether or not to calibrate the skew.

Calibrate Mean Reversion—Whether or not to calibrate the mean reversion.

Correlation—Correlation between two processes.

Domestic Yield Curve—Domestic Yield Curve calculates the NPV (net present value), which is the discount value of the cash flow, using the domestic currency.

Foreign Yield Curve—Foreign Yield Curve calculates the NPV (net present value), which is the discount value of the cash flow, using the foreign currency.

Lambda—Lambda is the partial derivative of the option price with respect to the option volatility. Lambda is used as a synonym for vega, kappa, or sigma.

Lambda Max—Maximum value for lambda.

Max Date—Date up to which to calibrate.

Max HW Volatility—The maximum Hull & White volatility.

Max Mean Reversion—Maximum mean reversion to use during the calibration. Default: 20.

Mean Reversion—Either constant mean reversion or lowest mean reversion.

Mean Reversion 1—Mean reversion for process one.

Mean Reversion 2—Mean reversion for process two.

Mean Reversion 3—Mean reversion for process three.

Nb Points—This gives the granularity of the mean reversions to use. Default: 1000.

Now Date—Now date for calibration.

Reference Date—Now date for calibration.

Rho—Correlation between volatility processes and price processes.

Rho Max—Maximum value for rho.

Rho12—Correlation between process one and two.

Rho13—Correlation between process one and three.

Rho23—Correlation between process two and three.

Skew—Volatility skews occurs where two or more options on the same underlying asset have considerable differences in implied volatility. There are two type of volatility skews, a volatility time skew and a volatility strike skew. Volatility skew is used to identify trading opportunities.

Spot—Spot FX rate at the now date.

Theta—The value to which the volatility squared process reverts.

Time Dependent—Whether or not to calibrate time dependent volatilities.

Tolerance—This is the tolerance required on the mean reversion.

Vol0—Initial volatility.

Vol0 Min—Minimum initial volatility.

Vol ATM—Implied volatility of this option.

Vol Max—Maximum volatility.

VolSquare0—Initial value of the volatility squared.

Xi—Volatility of volatility.

Xi Max—Maximum value for Xi.

Yield Curve—Yield Curve calculates the NPV (net present value), which is the discount value of the cash flow.

### APPENDIX C

### Glossary of Instanced Deal Properties

The following illustrative list relates to deal capture and integration techniques involving Reuters Kondor+ financial management suite. In this implementation, if a property is labeled as mandatory, then a deal insertion, update, financial analysis, or pricing operation will fail unless a field with the property is provided. If a property is labeled as optional, then the field may be displayed and used during deal insertion, update, financial analysis, or pricing operations. If a property is labeled as used for deal searching, then the deal search results returned to the user will only include deals in which the property is present.

Broker—Optional. You may add a field of type Block:Broker with a KondorName Property Broker to associate the value with the Broker defined in Kondor+ for a deal. This property is optional for deal insertion, and is used for search. Default: none.

Brokerage—Optional. You may add a field of type Double with a KondorName Property Brokerage to associate the value with the Brokerage defined in Kondor+ for a financial report. This property is optional for financial analysis.

Counterparty—Optional. You may add a field of type Block:Counterparty with a KondorName Property Counterparty to associate the value with the Counterparty defined in Kondor+ for a deal. This property is optional for financial analysis, and optional for deal insertion. This property is used for search. Default: none.

Currency—Mandatory. A field of type Block:Currency with a KondorName Property Currency must be added to all Products. This property associates the value with the Currency defined in Kondor+ for a deal. This property is mandatory for pricing, financial analysis, and deal insertion, and is used for deal search.

Folder—Mandatory. A field of type Block:Folder with a KondorName Property Folder must be added to all Products. This property associates the value with the Folder defined in Kondor+ for a deal. This property is mandatory for pricing, financial analysis, and deal insertion, and is used for deal search.

Gross_Amount—Optional. You may add a field of type Double with a KondorName Property Gross_Amount to associate the value with the Gross_Amount defined in Kondor+ for a financial report. This property is optional for financial analysis.

Maturity_Date—You must add a mandatory Field of type Date with a KondorName Property Maturity_Date to all Products. This associates the value with the Maturity_Date defined in Kondor+ for a deal. This is mandatory for pricing, financial analysis and deal insertion. It is used for deal search.

Quantity—Optional. You may add a field of type Double with a KondorName Property Quantity to associate the value with the Quantity defined in Kondor+ for a deal. This property is optional for financial analysis, and deal insertion. Default is 1 if the Quantity property is not defined. If the property is defined, the property value should be assigned or it defaults to 0.

Seller—Optional. You may add a field of type Block:Seller with a KondorName Property Seller to associate the value with the Seller defined in Kondor+ for a deal. This property is optional for deal insertion, and is used for search. Default: none.

Settlement_Date—Optional. You may add a field of type Date with a KondorName Property Settlement_Date to associate the value with the Settlement_Date defined in Kondor+ for a deal. This property is optional for financial analysis and deal insertion, and is used for search. Default: Value_Date.

Trade_Date—Mandatory. A field of type Date with a KondorName Property Trade_Date must be added to all Products. This property associates the value with the Trade_Date defined in Kondor+ for a deal. This property is mandatory for deal insertion and financial analysis, and is used for deal search.

Underlying—Mandatory. A field with a KondorName Property Underlying must be added to all Products where quote and discrete dividend curves are calculated. The Attribute Type depends on the financial instrument. You can use Block: Basket, Bond, Equity, Future, Option, Paper, Warrant. This property associates the value with the Underlying defined in Kondor+ for a deal. This property is mandatory for pricing.

Value_Date—Mandatory a field of type Date with a KondorName Property Value_Date must be added to all Products. This property associates the value with the Value_Date defined in Kondor+ for a deal. This property is mandatory for deal insertion and financial analysis, and is used for deal search.

### APPENDIX D

### Glossary of Blocks

In this example, any deal may be built as a combination of three fundamental structures: financial blocks, attributes, and properties.

Blocks—A component that may be reused for the creation of a new type of financial product. A block is composed of attributes and properties. A block may inherit from another block. Blocks are used to define taxonomy. A block may be used to define a part of a new typed of financial product, a static data object, or a market data object.
Examples: leg, barrier block, bond, yield curve.

Attribute—A field of a block or a characteristic of a product. The user may attach properties to an attribute to define the behaviors of the attribute. An attribute may be of a basic computer data type (e.g., double, string, date) or may be of a complex type (e.g., block) so that an aggregation of blocks is possible.
Examples: maturity date of the product, the barrier level, issue date.

Properties—the behaviors of an attribute (e.g., Visible, Column, DisplayLabel, LayoutType, etc.). Also may be referred to as a Facet.
Examples: default value, graphical user interface (GUI) for positioning a graphical widget, link with the pay-off script, back office behavior for the fixing management.

Products—Used to define a new type of financial products. A product is a kind of block for which the user can define a payoff script or attach a set of rules. An instance of product is referred to as a deal.
Example: lookback option, callable snowball.

K+ Block—Used to define static data of the financial product suite. This type of object may be dynamically linked with the suite and may allow the user to retrieve data from the financial product suite.
Example: Portfolio, counterparty, bond, equity, index, yield curve, in fact all common static data.

Schedule—A specific block connected to a schedule generator. Schedule blocks may allow the user to define a product. A schedule may be a defined array of dates (e.g., fixing dates, payment dates, start dates, end dates) and may be linked to schedule parameters.

Schedule parameters—A specific block that defines the input parameters of the schedule generator used in the schedule block.
Example: start date, end date, frequency, roll convention, calendar.

Choice—A simple enumerative that can be used in a block. (Put/Call, Buy/Sell, etc.)

Deal—An instance of product. A deal may be priced and/or inserted via the financial suite interface 562 using the runner user interface 520.

### APPENDIX E

### Example of Default Properties

In this example, when a user creates a field, the following set of default properties may be assigned depending on the Field Type. The user may modify the Property Value for the default Properties.

| Field Type | Default Property |
|---|---|
| Boolean | DisplayColumn |
| Date | DisplayLabel |
| Choice | DisplayOrder |
| Integer | LayoutType |
| Tenor | |
| Array of Booleans | |
| Array of Blocks | |
| Array of Dates | |
| Array of Doubles | |
| Array of Choices | |
| Array of Integers | |
| Array of Strings | |
| Double | DisplayColumn |
| String | DisplayLabel |
| | DisplayOrder |
| | LayoutType |
| | Short |
| Block | DisplayColumn |
| | DisplayLabel |
| | DisplayOrder |
| | LayoutType |
| | ContainerType |
| | Expandable |
| | Scrollable |

1. A method of creating a financial product type, comprising:
(a) providing a computer user interface associated with a financial management software application;
(b) receiving via the computer user interface input data for creating a financial product type, the input data identifying at least one financial instrument and at least one parameter of a financial product type;
(c) generating a meta language script based on the received input data;
(d) creating a software object corresponding to a financial product type using the meta language script, wherein the financial product type is based on the at least one financial instrument and the at least one parameter; and
(e) updating the functionality of the financial management software application to provide access to the software object corresponding to the financial product type through the financial management software application.

2. The method of claim 1, further comprising:
(f) receiving a request via the financial management software application to initiate a trading activity involving the financial product type; and
(g) invoking a function of the software object corresponding to the requested trading activity.

3. The method of claim 2, wherein the requested trading activity corresponds to one or more of trading, selling, pricing, or performing a risk management analysis on the financial product type.

4. The method of claim 2, wherein the requested trading activity comprises pricing the financial product type using a financial model software component embedded into the financial management software application.

5. The method of claim 1, wherein the software object supports pricing and risk-management functionality for the software object, and wherein updating the functionality of the financial management software application comprises supporting trades and sales of the financial product type by users of the financial management software application.

6. The method of claim 1, further comprising invoking functions supported by the software object, wherein the invoking comprises interpreting code of the software object by a virtual machine.

7. The method of claim 1, wherein updating the functionality of the financial management software application comprises displaying a representation of the financial product type in a user interface of the financial management software application, wherein the representation of the financial product type is displayed in a list of other financial product types that are available for trading activities.

8. A computing device configured to create a financial product, comprising:
a processor configured to control at least some operations of the computing device;
memory storing computer executable instructions that, when executed by the processor, cause the computing device to perform a method comprising:
(a) executing a financial management software application comprising a user interface for creating a financial product type;
(b) receiving via the user interface input data identifying at least one financial instrument and at least one parameter of a financial product type;
(c) generating a meta language script based on the received input data;
(d) creating a software object corresponding to a financial product type using the meta language script, wherein the financial product type is based on the at least one financial instrument and the at least one parameter; and
(e) updating the functionality of the financial management software application to provide access to the created software object through the financial management software application.

9. The computing device of claim 8, wherein the method further comprises:
(f) receiving a request via the financial management software application to initiate a trading activity involving the financial product type, wherein the requested trading activity corresponds to one or more of trading, selling, pricing, or performing a risk management analysis on the financial product type; and
(g) invoking a function of the software object corresponding to the requested trading activity.

10. The computing device of claim 9, wherein the requested trading activity corresponds to one or more of trading, selling, pricing, or performing a risk management analysis on the financial product type.

11. The computing device of claim 9, wherein the requested trading activity comprises pricing the financial product type using a financial model software component embedded into the financial management software application.

12. The computing device of claim 9, wherein the requested trading activity comprises a risk management analysis involving the created financial product type and at least one other financial product type that is available for trading activities via the financial management software application.

13. The computing device of claim 9, further comprising:
memory storing a virtual machine configured to execute concurrently with the financial management software application, wherein invoking the software object comprises interpreting code of the software object by the virtual machine.

14. The computing device of claim 8, wherein updating the functionality of the financial management software application comprises displaying a graphical representation of the financial product type in a list of other financial product types that are available for trading activities via the financial management software application.

15. One or more computer readable media storing computer-executable instructions which, when executed on a computer system, perform a method comprising:
(a) providing a user interface for a financial management software application;
(b) receiving via the user interface input data identifying at least one financial instrument and at least one parameter of a financial product;
(c) generating a meta language script based on the received input data;
(d) creating a software object corresponding to a financial product type using the markup language data script, wherein the financial product type is based on the at least one financial instrument and the at least one parameter; and
(e) updating the functionality of the financial management software application so that functions of the created software object are accessible via the user interface of the financial management software application.

16. The computer readable media of claim 15, wherein the method further comprises:
(f) receiving a request via the financial management software application to initiate a trading activity involving the financial product type; and
(g) invoking a function of the software object corresponding to the requested trading activity.

17. The computer readable media of claim 16, wherein the requested trading activity comprises pricing the financial product type using a financial model software component embedded into the financial management software application.

18. The computer readable media of claim 16, wherein the requested trading activity comprises a risk management analysis involving the created financial product type and at least one other financial product type represented by the financial management software application.

19. The computer readable media of claim 16, wherein invoking the function of the software object corresponding to the requested trading activity comprises interpreting code of the software object by the virtual machine.

20. The computer readable media of claim 15, wherein updating the functionality of the financial management software application comprises displaying a graphical representation of the financial product type in a list of other financial product types that are available for trading activities via the financial management software application.
